(19) United States
(12) Patent Application Publication
(10) Pub. No.: US 2022/0108218 A1
(43) Pub. Date: Apr. 7, 2022

(54) QUANTUM-ASSISTED MACHINE LEARNING WITH TENSOR NETWORKS

(71) Applicant: The Johns Hopkins University, Baltimore, MD (US)

(72) Inventors: Michael L. Wall, Huntsville, AL (US); Matthew R. Abernathy, Huntsville, AL (US); Gregory D. Quiroz, Chevy Chase, MD (US)

(21) Appl. No.: 17/481,472

(22) Filed: Sep. 22, 2021

Related U.S. Application Data
(60) Provisional application No. 63/086,073, filed on Oct. 1, 2020.

(51) Int. Cl. G06N 20/00; G06N 5/00; G06N 10/00

(52) U.S. Cl. CPC G06N 20/00; G06N 10/00; G06N 5/003

(57) ABSTRACT

A method for quantum-assisted machine learning includes encoding, by processing circuitry, classical data into a plurality of quantum states by applying the classical data to an encoding map, and training a quantum model based on the plurality of quantum states. The quantum model may have a tensor network structure. The method may also include compiling, by the processing circuitry, the quantum model into a quantum circuit by mapping virtual qubits onto hardware qubits of a quantum hardware device, the quantum circuit including a sequence of operations tailored for operation on the quantum hardware device.

### CROSS-REFERENCE TO RELATED APPLICATIONS

This application claims the benefit of prior-filed, co-pending U.S. Provisional Application No. 63/086,073 filed on Oct. 1, 2020, the entire contents of which are hereby incorporated herein by reference.

### TECHNICAL FIELD

Example embodiments generally relate to quantum computing and, more particularly, relate to techniques for significantly improve the efficient and reliable operation of the quantum devices.

### BACKGROUND

Noisy, intermediate-scale quantum (NISQ) computing devices have become an industrial reality recently, and cloud-based interfaces to these devices are enabling exploration of near-term quantum computing on a range of problems. However, NISQ devices can often be noisy in that the error rate for results of and operation can be relatively high. In some instances, NISQ devices may be too noisy for many algorithms having a known quantum advantage, and therefore the utility of such noisy NISQ devices is significantly diminished. As such, improvements and innovation in the realm of quantum computing to find ways to reduce or eliminate the effect of noisy operation of quantum devices is needed.

### BRIEF SUMMARY

According to some non-limiting, example embodiments, an example method for quantum-assisted machine learning is provided. The example method includes encoding, by processing circuitry, classical data into a plurality of quantum states by applying the classical data to an encoding map. The example method may further include training a quantum model based on the plurality of quantum states. In this regard, the quantum model may have a tensor network structure. The example method may further include compiling, by the processing circuitry, the quantum model into a quantum circuit by mapping virtual qubits onto hardware qubits of a quantum hardware device. The quantum circuit may include a sequence of operations tailored for operation on the quantum hardware device.

According to additional example embodiments, an apparatus for developing quantum-assisted machine learning systems is provided. The apparatus includes processing circuitry that is configured to encode classical data into a plurality of quantum states by applying the classical data to an encoding map. The processing circuitry may also be configured to train a quantum model based on the plurality of quantum states. In this regard, the quantum model may have a tensor network structure. The processing circuitry may also be configured to compile the quantum model into a quantum circuit by mapping virtual qubits onto hardware qubits of a quantum hardware device. The quantum circuit may include a sequence of operations tailored for operation on the quantum hardware device.

### BRIEF DESCRIPTION OF THE SEVERAL VIEWS OF THE DRAWING(S)

Having thus described the example embodiments in general terms, reference will now be made to the accompanying drawings, which are not necessarily drawn to scale, and wherein:

FIG. 1 is a flowchart of an example method for a quantum-assisted machine learning workflow according to some example embodiments;

FIG. 2 is a plot of a matrix representation of an isometry according to some example embodiments;

FIG. 3 is a plot of matrix representations of an isometry with and without application of a permutation procedure according to some example embodiments;

FIG. 4 illustrates an example qubit/gate topology for a noisy, intermediate-scale quantum (NISQ) system according to some example embodiments;

FIG. 5 illustrates a greedy compilation procedure according to some example embodiments;

FIG. 6A illustrates matrix representations of an isometry and optimized gates according to some example embodiments;

FIG. 6B illustrates optimized quantum circuits according to some example embodiments;

FIG. 7 illustrates an example dataset for an exactly solvable matrix product states according to some example embodiments;

FIG. 8 illustrates circuit decompositions according to some example embodiments;

FIG. 9A illustrates isometry plots and an optimized circuit for an example site 0 according to some example embodiments;

FIG. 9B illustrates isometry plots and an optimized circuit for an example site 1 according to some example embodiments;

FIG. 9C illustrates isometry plots and an optimized circuit for an example site 2 according to some example embodiments;

FIG. 10 illustrates a comparison of a hand-complied and an auto-complied circuits for an exactly solvable test case according to some example embodiments;

FIG. 11 illustrates comparison charts for ideal, measured, and noise-corrected outcomes of quantum hardware according to some example embodiments;

FIG. 12 illustrates example convex Kullback-Leibler divergence between ideal and measured outcomes according to some example embodiments;

FIG. 13 is a block diagram of an example apparatus with processing circuitry configured to perform a quantum-assisted machine learning workflow according to some example embodiments; and

FIG. 14 is a block diagram of an example method for performing a quantum-assisted machine learning workflow according to some example embodiments.

### DETAILED DESCRIPTION

Some non-limiting, example embodiments now will be described more fully hereinafter with reference to the accompanying drawings, in which some, but not all, example embodiments are shown. Indeed, the examples described and pictured herein should not be construed as being limiting as to the scope, applicability, or configuration of the present disclosure. Rather, these example embodiments are provided so that this disclosure will satisfy applicable legal requirements. Like reference numerals refer to like elements throughout.

As used herein the term “or” is used as the logical or where any one or more of the operands being true results in the statement being true. As used herein, the phrase “based on” as used in, for example, “A is based on B” indicates that B is a factor that determines A, but B is not necessarily the only factor that determines A.

According to some example embodiments, methods, apparatuses, and systems are provided herein that are related to various example implementations of quantum-assisted machine learning leveraging tensor networks (TNs). A tensor network may be a type or class of variational wave functions that can be used to study and model, for example, many-body quantum systems. In this regard, according to some example embodiments, methods for quantum-assisted machine learning may be implemented using TNs and a statistical model based on a classical data set. Such techniques may further employ optimizations that may be particularly useful in the context of noisy intermediate-scale quantum (NISQ) devices, thereby increasing the utility of such devices. Additionally, some example methods may utilize an embedding or encoding map to transform a classical data set into quantum states and then apply to optimization methodologies to train a TN model on a classical device. The TN model may define a formal sequential preparation scheme to deploy on a gate-based quantum device or computer in the form of a quantum circuit and an associated quantum program.

According to some example embodiments, the example methods may use remaining ambiguity in the TN model to make the model more amenable to compilation on a quantum device. In this regard, heuristics may be used for translating the TN model into an abstract quantum circuit for a quantum device with known noise, gate set, and hardware topology constraints. The abstract circuit model can be deployed on, for example, quantum hardware devices including cloud-based quantum hardware. Measurements from the quantum device implementing the abstract circuit model may define data samples that can be analyzed to assess model performance. In this regard, the example methods may therefore produce quantum programs or circuits, which may be analogous to programs in classical assembly language, that can be, for example, a factor of ten shorter in operations than quantum programs produced using conventional methods. Also, NISQ devices can have error rates of approximately 1% or more, and therefore, a reduction in quantum program size (e.g., number of commands) can result in an vast improvement in error rate since each command may contribute to the chances of an error occurring. As such, the usability of such NISQ devices can be increased since the risk of errors can be substantially reduced.

As such, according to some example embodiments, example methods may include converting from a representation of a tensor network machine learning model into a collection of instructions to be performed on a quantum device. The model may be specified as a collection of isometric matrices, obtained as the result of an optimization procedure with finite stopping tolerance, that can be translated into a set of allowed quantum operations on a quantum device with a fixed layout and noise characteristics. In contrast to most quantum computing use cases in which the operations to be performed require fine-tuning to produce useful outcomes, the statistical nature of the model may introduce “tolerance” or “slackness” that can reduce fidelity constraints for the quantum operations. As such, ambiguity in the parameters of the model and the “slackness” property may be leveraged to optimize deployment on quantum resources without sacrificing utility of the model outcomes. According to some example embodiments, example methods may differ from conventional approaches for compilation of quantum operations and can produce significantly shorter quantum programs without sacrificing output quality for implementation on, for example, noisy quantum computing hardware.

The example methods and apparatuses performing the methods, may find applicability in a vast number of contexts. For example, example methods may be employed by commercial-quantum hardware providers for use in developing application programming interfaces (APIs) for quantum devices. Further, the example methods as described herein may be applied in quantum-assisted machine learning contexts and applications of a wide variety.

As such, according to some example embodiments, quantum-assisted machine learning (QAML) on, for example, NISQ devices may be implemented by leveraging the use of TNs, which can offer a robust platform for designing resource-efficient and expressive machine learning models to be dispatched on quantum devices. In particular, according to some example embodiments, an example framework and variations thereof are provided herein for designing and optimizing TN-based QAML models using classical techniques, and then compiling the TN-based QAML models to be run on quantum hardware, which can be demonstrated for generative matrix product state (MPS) models. As such, a generalized canonical form for MPS models is provided that aids in compilation to quantum devices. Further, greedy heuristics may be used for compiling with a given topology and gate set that may outperform known generic methods in terms of a number of entangling gates, e.g., CNOTs (controlled NOT gates), in some cases by an order of magnitude. A solvable (or exactly solvable) benchmark problem may also be used for assessing the performance of the MPS QAML models according to various example embodiments. The impacts of hardware topology and day-to-day experimental noise fluctuations on model performance can be considered by analyzing both raw experimental counts and statistical divergences of inferred distributions. Additionally, parametric studies of depolarization and readout noise impacts on model performance using hardware simulators can also be considered.

Gate-based quantum computing has emerged as a relatively mature technology, with many platforms offering cloud-based interfaces to machines with a few to dozens of qubits, as well as classical emulators of quantum devices. The quantum computing resources, however, can, in some instances, be limited in the number of qubits despite, for example, millions of qubits being required to perform certain canonical quantum computing tasks such as integer factorization with error correction. Further, some quantum computing resources may be either engineered with a specific demonstration goal or designed for general-purpose research-scale exploration. However, in the context of noisy NISQ devices, whose hardware noise and limited qubit connectivity and gate sets can pose challenges for demonstrating scalable universal quantum computation, a different form of quantum application discovery may be considered in which algorithms may be required to be robust to noise, limited qubit connectivity and gate sets, and highly resource-efficient.

Such NISQ devices may be leveraged in the context of machine learning (ML) because well-performing ML algorithms can feature robustness against noise. Additionally, quantum circuits can be designed for ML applications that are highly qubit-efficient, and quantum models can be designed whose expressibility increases exponentially with qubit depth. In this regard, one ML application, for example, may involve implementation of NISQ devices in the context of quantum-assisted machine learning, in which a quantum circuit's parameters are classically optimized based on measurement outcomes that may not be efficiently classically simulable, which may also include kernel-based learning schemes with a quantum kernel. According to some example embodiments, TNs can provide a robust means of designing such parameterized quantum circuits that are quantum-resource efficient and can be implemented and optimized on classical or quantum hardware. TN-based QAML algorithms, according to some example embodiments, can leverage optimization strategies for TNs, and also enable detailed benchmarking and design of QAML models classically, with a smooth transition to classically intractable models.

The applicability of QAML with TN architectures on NISQ hardware and hardware simulators is described according to some example embodiments. Further, hardware noise, qubit connectivity, and restrictions on gate sets may also be considered. Fully generative unsupervised learning tasks may be considered for QAML with, for example, the most resource-efficient matrix product state (MPS) TN topology. A framework is provided for QAML, according to some example embodiments, that includes translation of classical data into quantum states, optimization of an MPS model using classical techniques, the conversion of this trained model into a sequence of isometric operations to be performed on quantum resources, and the optimization and compilation of these isometric operations into native operations for a given hardware topology and allowed gate set. In this regard, according to some example embodiments, the framework may involve QAML with TNs in association with embedding classical data into quantum states, classical training of a TN model, and the conversion of TN models into resource-efficient sequential preparation schemes. Further, techniques, according to some example embodiments, are provided for the compilation stage aimed at TN models for QAML on devices including NISQ devices. Such techniques may include the permutation of auxiliary quantum degrees of freedom in the TN to optimize mapping to hardware resources and heuristics for the translation of isometries into native operations minimizing or using as few entangling operations (e.g., CNOTs) as possible. In this regard, the framework may further involve compiling TN-based QAML models for running on quantum hardware, including the utilization of ambiguity in the TN representation and greedy compilation heuristics for minimizing model gate depth. According to some example embodiments, the example methods described herein may enable the robust design and performance assessment of QAML models on NISQ devices in the regime where classical simulations are possible, and may also inform architectures and noise levels for scaling to the classically intractable regime. Even in the classically intractable regime in which the model can be optimized using a quantum device in a hybrid quantum/classical loop, the example methods may provide a means of obtaining an approximate, classically trained “preconditioner” for the quantum models that can help avoid local minima and reduce optimization time. Further, results can be provided, according to some example embodiments, for synthetic data that can be described by, for example, an exactly solvable two-qubit MPS QAML model.

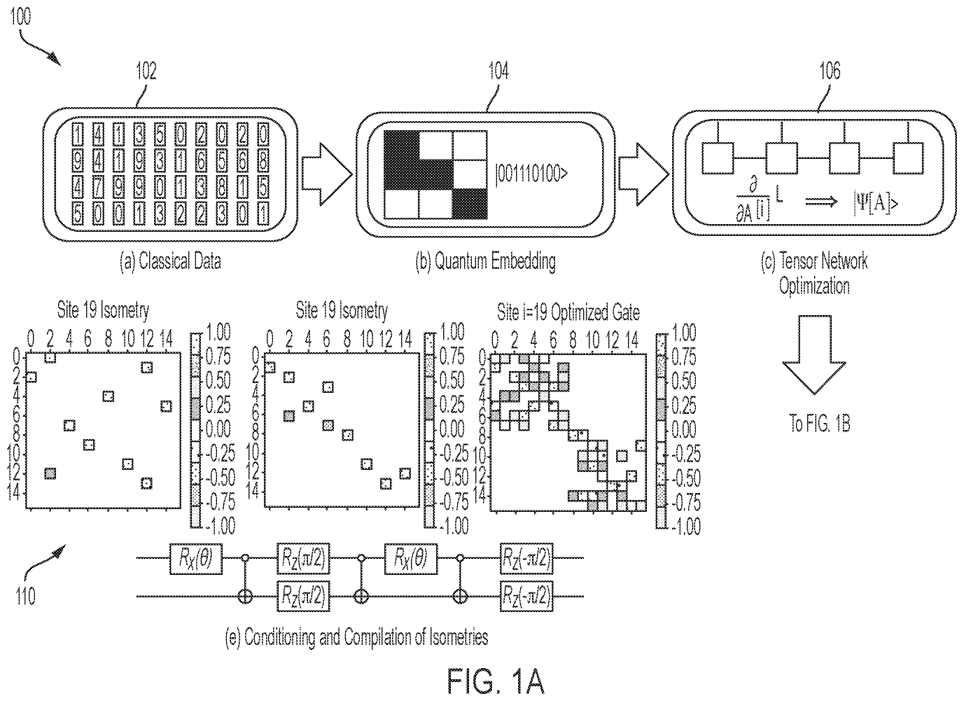

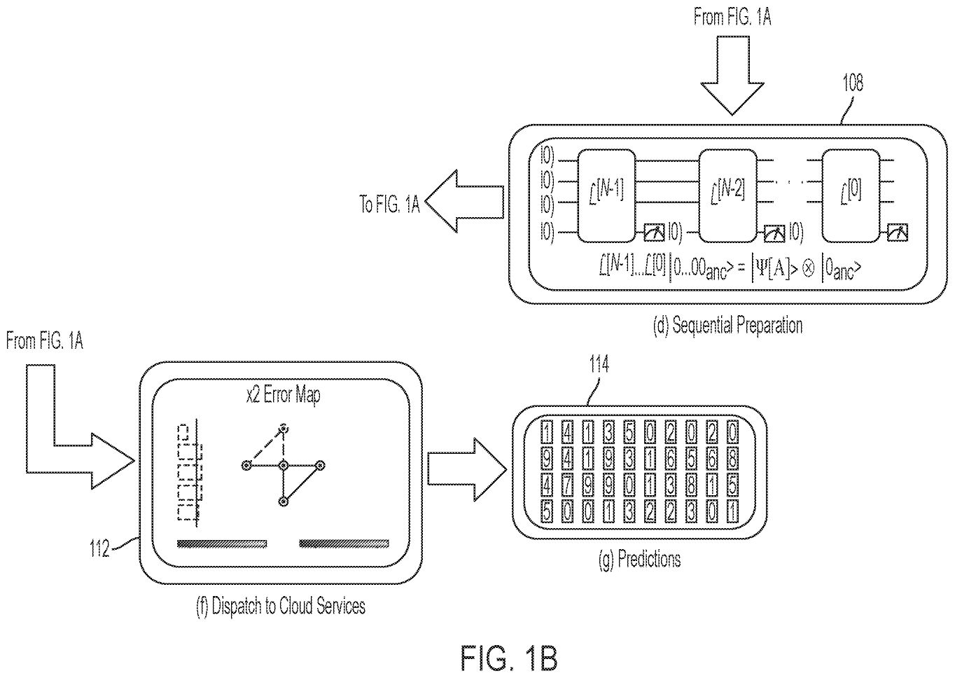

With respect to QAML with TN, FIG. 1 provides an example method 100 for a QAML workflow according to some example embodiments. In short, at 102, classical data may be received or otherwise obtained, and, at 104, quantum embedding or encoding may be performed where the classical data may be pre-processed and transformed to quantum states embedded, for example, in an exponentially large Hilbert space. At 106, a TN optimization may be performed where a TN model may be learned from a collection of quantum training data. At 108, the TN model may be interpreted using a sequential preparation scheme involving a number (e.g., a small number) of readout qubits coupled to ancillary resources. At 110, isometries of the sequential preparation scheme may be conditioned using inherent freedom in the TN model representation and converted (or compiled) into native gates for a target hardware architecture (e.g., a processor such as the IBMQ-X2 processor). At 112, the native gates or a variation thereof may be executed on hardware, such as, for example, cloud-based hardware and measurements defining output predictions may be obtained at 114.

Having provided a general overview of the example method 100, a more detailed description of the operations of example method 100 will now be provided. In this regard, a collection of classical data vectors in a training set [symbol] ={xⱼ}ⱼ₌₁^{N}^{_{T}} may be received at 102, where each element xⱼ is an N-length vector. The classical data vectors may therefore be mapped to vectors in, for example, a quantum Hilbert space to be quantum embedded or encoded at 104. According to some example embodiments, a restriction that may be placed on the encoding of classical data in quantum states may be that each classical data vector can be encoded in an unentangled product state, which may be beneficial for at least the following reasons. For one, unentangled states can be the simplest to prepare experimentally with high fidelity, and also enable the use qubit-efficient sequential preparation schemes. From a learning perspective, encoding individual data vectors in product states may also ensure that any entanglement that results in a quantum model may be a result of correlations in an ensemble of data and not from a priori assumptions about pre-existing correlations for individual data vectors. For encoding of an N-dimensional classical data vector x into an ensemble of N qubits, a convenient parameterization may be

$$\vert Φ ( x ) 〉 = {{⊗}_{j = 0}}^{N - 1} ( {\sum }_{i , j = 0}^{1} {ϕ}_{j} ( {x}_{i} ) \vert {i}_{j} 〉 ) ; \qquad ( 1 )$$

that is, in terms of local maps ϕⱼ(x) mapping a single data element into a superposition of qubit quantum states. In order that the full map Φ(x) maps each data instance into a normalized vector in Hilbert space, it may be required that

$${\sum }_{j} {\vert {ϕ}_{j} ( x ) \vert}^{2} = 1 ∀ x . \qquad ( 2 )$$

When encoding data for use in generative applications, it may also be useful for the maps to have the orthonormality property

$${\prod }_{j = 0}^{N - 1} \int {dx}_{j} {ϕ}_{{i}_{j}}^{★} ( {x}_{j} ) {ϕ}_{{i}_{j}^{′}} ( {x}_{j} ) = {\prod }_{j} {δ}_{{i}_{j} , {i}_{j}^{′}} , \qquad ( 3 )$$

which ensures that the wavefunction encoding data

$$\vert ψ 〉 = {\sum }_{{i}_{0} … {i}_{N - 1}} {c}_{{i}_{0} … {i}_{N - 1}} \vert {i}_{0} … {i}_{N - 1} 〉 , \qquad ( 4 )$$

is normalized whenever

$${\sum }_{{i}_{0} … {i}_{N - 1}} {\vert {c}_{{i}_{0} … {i}_{N - 1}} \vert}^{2} = 1. \qquad ( 5 )$$

That is, maps satisfying Eq. (3) may map the data into an orthonormal Hilbert space.

According to some example embodiments, a simplest case may occur when the data is discrete, and can be formulated as vectors x where xⱼ∈{0, 1}. Each element may therefore be mapped to a qubit as

ϕⱼ(x)=∂_{j,x} (6)

This mapping may satisfy the properties of Eqs. (2) and (3) above, and may therefore be suitable for either generative or discriminative applications. In the case in which the data is continuous, x∈ [symbol] ^{N}, the date can be encoded in Hilbert space. The phase-like encoding

$${ϕ}_{0} ( x ) = cos ( \frac{π}{2} \frac{x - {x}_{min}}{{x}_{max} - {x}_{min}} ) , \\ {ϕ}_{1} ( x ) = sin ( \frac{π}{2} \frac{x - {x}_{min}}{{x}_{max} - {x}_{min}} ) , \qquad ( 7 )$$

can be used to encode data for quantum-inspired ML applications. Because Eq. (7) may satisfy Eq. (2) but not Eq. (3), a related map that satisfies both conditions may be

$${ϕ}_{0} ( x ) = {e}^{3 π ix / 2} cos ( \frac{π}{2} \frac{x - {x}_{min}}{{x}_{max} - {x}_{min}} ) , \\ {ϕ}_{1} ( x ) = {e}^{- 3 π ix / 2} sin ( \frac{π}{2} \frac{x - {x}_{min}}{{x}_{max} - {x}_{min}} ) . \qquad ( 8 )$$

However, focus will be placed on the case of binary data for explanation purposes, and therefore map Eq. (6) may be utilized.

At 106, a next step in the example QAML workflow method may be to learn or train a quantum model for the collection to quantum states {|Φ(xⱼ) [symbol] }ⱼ₌₁^{N}^{_{T}} resulting from applying the encoding map from operation 104 to the training data. Here, the quantum model may be defined as a collection of operations applied to quantum resources to produce states that encodes the properties of the ensemble {|Φ(xⱼ) [symbol] }. Specializing to the use of TN models in this context can provide a convenient parameterization of the structure of quantum operations and resources. The TNs may, according to some example embodiments, represent the high-rank tensor by describing a quantum wavefunction in a specified basis as a contraction over low-rank tensors, and may therefore define families of low-rank approximations whose computational power can be expressed in terms of the maximum dimension of any contracted index X, known as the bond dimension.

According to some example embodiments, a wide variety of TN topologies can be considered which may be able to efficiently capture certain classes of quantum states. One example may be matrix product states (MPSs). MPSs may use a one-dimensional TN topology, as shown using the Penrose graphical notation 105 in FIG. 1 for tensors, and form the basis for the density matrix renormalization group (DRAG) algorithm in quantum condensed matter physics. MPSs have several properties that may be attractive for QAML. For one, MPSs are well-understood and mature for tensor networks, therefore allowing for robust optimization strategies used in quantum many-body community applications. In addition, MPSs can be highly quantum resource efficient, in that an associated wavefunction can be sequentially prepared, and therefore qubits can be reused in deployment on quantum hardware. As such, according to some example embodiments, every state that can be sequentially prepared may be written as an MPS.

TNs can also be applied outside of the condensed matter and quantum information domains. For example, TN methods may be used for data analysis, e.g., large-scale principal component analyses where MPSs may be referred to as tensor trains. Further, TN methods may be used to design quantum-inspired ML models based on a scheme using an MPS network as a linear classifier in a Hilbert space whose dimension is exponentially large in the length of the raw data vector. Quantum-assisted or quantum-inspired TN ML models may be used in generative modeling of binary data using MPSs. In some TN approaches, DMRG-inspired algorithms for optimization may be employed. Additionally, TNs may be implemented as a neural network using deep learning software, and the tensors of the TN may be optimized using backpropagation strategies in classical ML, but such approach, in some instances, has been suboptimal with respect to a DMRG-like approach.

Following from application of TNs in these contexts, example embodiments can leverage the fact that MPSs may be used to define a sequential preparation scheme as a highly resource efficient scheme for learning and quantum simulation. In this regard, the qubit resource requirements for an MPS model may be logarithmic in the bond dimension χ, which may encapsulate the expressivity of the model, and the qubit resource requirements may be independent of the length of the input data vector N. To illustrate this property, a register of N qubits may be considered with states |jᵢ [symbol] , i=0, . . . , N−1, jᵢ=0,1 in which data may be encoded and an χ-level ancilla |α [symbol] , α=0, . . . , χ−1 that can be used to entangle the qubits. The (N−1)^{st} qubit may be initialized, operating from the “right” of the system, using an operator \ddot{L}_{N-1} defined as

$${\hat{L}}_{N - 1} = {\sum }_{a , {j}_{N - 1}} {L}_{α}^{[ N - 1 ] {j}_{N - 1}} \vert {j}_{N - 1} α 〉 〈 00 \vert , \qquad ( 9 )$$

in which the coefficients L^{[N-1]} satisfy the isometry condition

$${\sum }_{a , {j}_{N - 1}} {L}_{α}^{{j}_{N - 1} ★} {L}_{α}^{{j}_{N - 1}} = 1. \qquad ( 10 )$$

If the qubit and ancilla system starts in the state |00 [symbol] the operation may transform into the (entangled) state Σ_{αjN-1}L_{α}^{j}^{_{N−1}}|αj_{N-1} [symbol] , and the isometry condition may ensure that the state can be normalized. Moving to the next qubit, the next qubit may be entangled with the ancilla using the operator

$${\hat{L}}_{N - 2} = {\sum }_{α , {j}_{N - 2} , β} {L}_{βα}^{[ N - 2 ] {j}_{N - 2}} \vert {j}_{N - 2} β 〉 〈 0 α \vert , \qquad ( 11 )$$

which is subject to the isometry condition

$${\sum }_{j} {𝕃}^{[ N - 2 ] j †} {𝕃}^{[ N - 2 ] j} = {χ}_{} , \qquad ( 12 )$$

with [symbol] _{χ} being the χ×χ identity matrix. This operation can now put the system in the state

$${\hat{L}}_{N - 2} {\hat{L}}_{N - 1} \vert {0}_{N - 2} {0}_{N - 1} {0}_{ancilla} 〉 = {\sum }_{{j}_{N - 2} , {j}_{N - 1} , α} {[ {𝕃}^{[ N - 2 ] {j}_{N - 2}} {𝕃}^{[ N - 1 ] {j}_{N - 1}} ]}_{α} \vert {j}_{N - 2} {j}_{N - 1} α 〉 . \qquad ( 13 )$$

The same logic may be followed for all subsequent qubits, thereby defining isometric operators that entangle the qubits to the rest of the system using the ancilla, until qubit 1 is reached, which is attached using the isometric operator

$${\hat{L}}_{0} = {\sum }_{{i}_{0} , β} \vert {i}_{0} 0 〉 〈 0 β \vert . \qquad ( 14 )$$

This operator can then put the full system into the state

$${\hat{L}}_{0} … {\hat{L}}_{N - 1} \vert {0}_{0} … {0}_{N - 1} {0}_{ancilla} 〉 = {\sum }_{{j}_{0} … {j}_{N - 1}} {𝕃}^{[ 0 ] {j}_{0}} … {𝕃}^{[ N - 1 ] {j}_{N - 1}} \vert {j}_{0} … {j}_{N - 1} {0}_{ancilla} 〉 . \qquad ( 15 )$$

Accordingly, in a next step, the qubit states may decouple from the ancilla. The qubit state may take the form of an MPS with the additional constraint that each of the MPS matrices [symbol] satisfies the left-orthogonal condition of Eq. (12). The example method described above, can also be read or performed in reverse, given a general MPS QAML model with bond dimension χ,

$${\sum }_{{j}_{0} … {j}_{N - 1}} {𝔸}^{[ 0 ] {j}_{0}} … {𝔸}^{[ N - 1 ] {j}_{N - 1}} \vert {j}_{0} … {j}_{N - 1} 〉 , \qquad ( 16 )$$

the example method can be converted into a sequential qubit preparation scheme with an χ-dimensional ancilla by putting the MPS in left-canonical form. This transformation to left-canonical form can be done without loss of generality using, for example, a procedure involving an orthogonal decomposition, e.g., the singular value or QR decomposition. Thus, the tensors appearing in an MPS, which could result from a classical training optimization, can be formally (i.e., modulo compilation into native quantum operations for a given hardware architecture) translated into operations for deployment on quantum resources.

The above example method assumed the presence of a register of N qubits. However, due to the sequential nature of the preparation, such assumption may be unnecessary, and a single “physical” qubit together with the χ-level ancilla may suffice, provided no multi-qubit properties of the state are being measured. As an example, a sample from an MPS wave function generative model may be drawn with the binary map of Eq. (6). In this application, for example, the qubit and ancilla may be coupled as in Eq. (9) starting from both in the fiducial state |0 [symbol] . The qubit may then be measured in the computational basis, and the outcome as x_{N-1} may be recorded. A return to the fiducial |0 [symbol] state may then be performed while leaving the ancilla unmeasured. According to some example embodiments, the ability to re-initialize a single qubit, independent of the others, may not be universally available depending on the implementing hardware. However, such re-initialization may be performed in, for example, trapped ion platforms. The ancilla and qubit may then be re-entangled using the operator Ĺ_{N-2} defined in Eq. (11), the qubit may be measured, and the outcome may be recorded as x_{N-2}. Further, the qubit may then be returned to the |0 [symbol] state. This portion of the example method may be repeated with the other operations \ddot{L}ⱼ until a complete set of N measurements x is made, which may constitute a data sample. This portion of the example method is shown graphically in FIG. 1 at 108. According to some example embodiments, the operations at 108 may only require a single “physical” or “data” qubit (i.e., the one that is sampled) independent of the input data size N, and the construction of the χ-level ancilla may require only log₂χ qubits.

According to some example embodiments, the example method described above may produce isometries acting on quantum resources without reference to an actual physical representation or other hardware constraints such as limited coherence time, connectivity, gate sets, etc. The translation of these isometries into operations to be dispatched on a given target hardware will now be described.

With regard to generative models, a collection of quantum data vectors may be encoded into a wavefunction such that the probability distribution evaluated at data vector x is

$$P ( x ) = \frac{〈 ψ \vert Φ ( x ) 〉 〈 Φ ( x ) \vert ψ 〉}{Z} . \qquad ( 17 )$$

Here, Z= [symbol] ψ|ψ [symbol] =∫dx [symbol] ψ|Φ(x) [symbol] [symbol] Φ(x)|ψ [symbol] may be a normalization factor, and the property Eq. (3) may be assumed to hold for the Hilbert space encoding map. Since this may correspond to Born's rule for measurement outcomes, the resulting structure may be referred to as a Born machine.

To discuss data representation using a Born machine, the average log-likelihood of the data in the training set [symbol] may be defined as

$$ℒ ( 𝒯 ) = \frac{1}{{N}_{T}} {\sum }_{x ∈ 𝒯} log [ \frac{〈 ψ \vert Φ ( x ) 〉 〈 Φ ( x ) \vert ψ 〉}{Z} ] . \qquad ( 18 )$$

The minimization of the negative log-likelihood with respect to the parameters in this Born machine may be equivalent to maximizing the probability that the data can be generated by the Born machine. The wavefunction may be parameterized to be trained as an MPS and the data may be assumed to be encoded in terms of an orthonormal map as in Eq. (3), resulting in

$$ℒ ( 𝒯 ) = \frac{1}{{N}_{T}} {\sum }_{x ∈ 𝒯} log [ {\sum }_{{i}_{0} … {i}_{N - 1} \vert {i}_{0}^{′} … {i}_{N - 1}^{′}} \frac{{\prod }_{j} {ϕ}_{{i}_{j}}^{★} ( {x}_{j} ) {ϕ}_{{i}_{j}^{′}} ( {x}_{j} )}{Z} \times Tr [ {𝔸}^{{i}_{0} †} … {𝔸}^{{i}_{N - 1} †} ] Tr [ {𝔸}^{{i}_{0}^{′}} … {𝔸}^{{i}_{N - 1}^{′}} ] ] , \qquad ( 19 )$$

where the normalization factor (partition function) may be

$$Z = {\sum }_{{i}_{0} … {i}_{N - 1}} Tr [ {𝔸}^{{i}_{0} †} … {𝔸}^{{i}_{N - 1} †} ] Tr [ {𝔸}^{{i}_{0}} … {𝔸}^{{i}_{N - 1}} ] . \qquad ( 20 )$$

The Born machine may be optimized by a DMRG-style procedure using gradient descent, where the gradient may be taken with respect to the tensors of the MPS. The gradient may be considered with respect to a group of s neighboring tensors Θ= [symbol] ⁱ^{ₗ} . . . [symbol] ⁱ^{ₗ₊ₙ}, with s typically being one or two, considering that the gradient of an object with respect to a tensor may be a tensor whose elements are the partial derivatives with respect to the individual tensor elements. The gradient may be taken with respect to the conjugates of the tensors [symbol] ⁱ^{ⱼ}, formally considering these conjugates independent of the tensors. As such, the gradient may be written as

$$\begin{matrix}{∇}_{{Θ}^{*}} ℒ ( 𝒯 ) = \frac{1}{{N}_{T}} {\sum }_{x ∈ 𝒯} \frac{{∇}_{{Θ}^{*}} 〈 ψ \vert Φ ( x ) 〉 〈 Φ ( x ) \vert ψ 〉}{〈 ψ \vert Φ ( x ) 〉 〈 Φ ( x ) \vert ψ 〉} - \frac{{∇}_{{Θ}^{*}} Z}{Z} , & ( 21 ) \\ = \frac{1}{{N}_{T}} {\sum }_{x ∈ 𝒯} \frac{{∇}_{{Θ}^{*}} 〈 ψ \vert Φ ( x ) 〉 〈 Φ ( x ) \vert ψ 〉}{〈 ψ \vert Φ ( x ) 〉 〈 Φ ( x ) \vert ψ 〉} - {\sum }_{x} \frac{{∇}_{{Θ}^{*}} 〈 ψ \vert Φ ( x ) 〉 〈 Φ ( x ) \vert ψ 〉}{Z} . & ( 22 )\end{matrix}$$

Having determined the gradient, the local block of tensors may be updated as

ι→Θ+η∇_{Θ}* [symbol] ( [symbol] ), *23)

in which η may be a learning rate, which may be equivalent to minimizing the negative log likelihood. For the single-site algorithm (s=1), this update need not change the bond dimension or canonical form of the MPS. For the two-site algorithm (s=2), the updated tensor Θ may be split into component MPS tensors as

$${Θ}_{αβ}^{ij} = {\sum }_{μ} {A}_{αμ}^{i} {A}_{μβ}^{j} , \qquad ( 24 )$$

using, e.g., the singular value decomposition (SVD). As such, the addition of the gradient may increase the bond dimension, and thus the representation power, adaptively based on the data. The bond dimension can also be set implicitly by, in some example embodiments, requiring that the L₂-norm of the tensor Θ be represented with a bounded relative error ∈. This update may affect, in some example embodiments, only a small group of the tensors with all others held fixed. The orthogonality center may then be shifted to a neighboring tensor, and the same or similar local optimization procedure may be performed. For example, for the two-site case, the shift of the orthogonality center can be accomplished simultaneously with the splitting of the tensor Θ in Eq. (24). In the one-site case, the orthogonality center may be moved to the next tensor in the optimization cycle using either the SVD or the QR decomposition. A complete optimization cycle, or “sweep,” may occur when, for example, all tensors have been updated twice, moving in a back-and-forth motion over the MPS. The sweeping process may be converged once the negative log-likelihood no longer decreases substantially (i.e., by a threshold amount).

According to some example embodiments, the MPS model resulting from the classical optimization procedure above, may be converted into a sequence of operations to be performed on a quantum device, which may be referred to as quantum compilation. Some NISQ software ecosystems, for example QISKIT® and FOREST®, have routines for compiling quantum instructions that are supplied in the form of an abstract quantum circuit model. Such compilers may perform multiple passes through the abstract circuit to map virtual qubits from the abstract model onto the hardware qubits of the device. Compliers may also route operations between the virtual qubits to hardware qubits, e.g., by placing SWAP gates (which swap two qubits), and via optimization to minimize some property of the circuit, such as the entangling gate count. According to some example embodiments, some methods for quantum compilation may produce “deep” circuits with significant numbers of entangling gates.

Based on the foregoing, several unique properties may exist in a quantum computing use case according to some example embodiments, such as compiling isometries encoding TN models for QAML. In this regard, the isometries can be defined on the Hilbert space of a physical qubit and a formal χ-level ancilla, and therefore the isometries may not uniquely describe an isometric operation on a set of virtual qubits, e.g., when χ is not a power of 2. Further, since the ancilla degrees of freedom may not be directly measured in some example embodiments, there may be no preferred basis or state ordering for these states. Both of these properties can give freedom that may be utilized to simplify compilation. In addition, the isometries may be the result of an optimization procedure that has a finite tolerance, as described above, and therefore do not need to be compiled exactly to meet a fine-tuned property. In other words, model predictions may not be more accurate when using a compiled unitary that matches the isometry better than the optimization tolerance. For implementation on NISQ devices, in particular, fine tuning of isometry properties through the introduction of additional entangling gates may produce, in some instances, diminished results due to the increased noise in the circuit compared to a shallower representation. As a result of these properties, optimizations of the tensor network structure may be performed and leverage a set of greedy compilation heuristics as further described below.

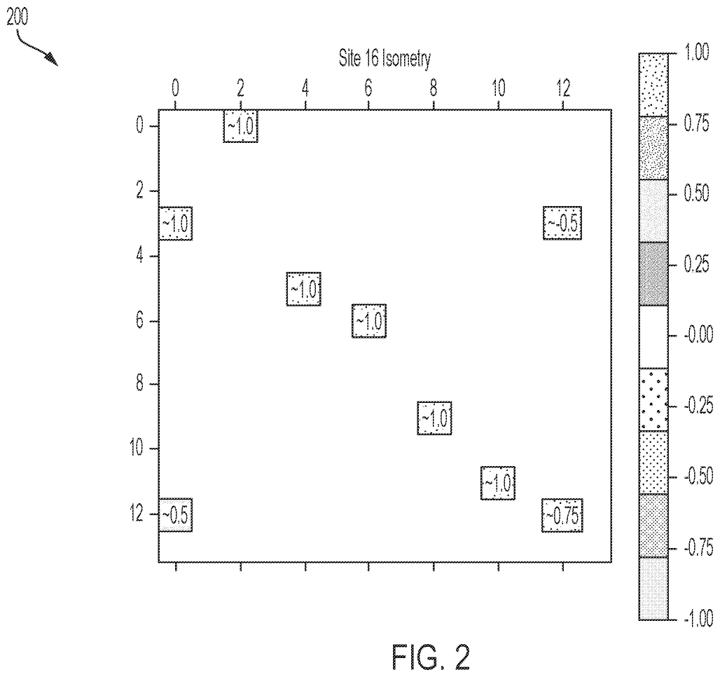

The objects targeted for optimization include the isometries \hat{L}^{[i]} defined by the elements of the MPS in the left canonical form, as described above. Since the binary encoding map, i.e., Eq. (6), may be real-valued, then all MPS tensors may also be real-valued, and therefore this extends to the isometries also being real-valued. The isometries may be displayed using plots of their matrix representations in a fixed basis, as in the plot 200 of FIG. 2.

In this regard, the plot 200 of FIG. 2 shows an example isometry for optimization acting on a single physical qubit in the state |0 [symbol] and χ=7-level ancilla. The isometry as shown in the plot 200 has been cleaned to remove small numerical values resulting from classical optimization, but no further optimization has been applied.

Accordingly, in the plot 200 and similar plots, the basis ordering may be defined with the physical qubit (i.e., the qubit that begins in the |0 [symbol] state and is read out after each isometric operation) as the least significant qubit such that an isometry acting on a χ-dimensional ancilla α∈{0, . . . , χ−1} and a physical qubit q∈{0, 1} has state indices

index(|αq [symbol] )=2α+q. (25)

For isometries that have their ancilla states decomposed into qubits, those qubits may be ordered αᵢ ∈{0, 1} such that significance increases with label index i, that is

$$index ( \vert {a}_{{n}_{anc}} … {a}_{1} q 〉 ) = {\sum }_{i = 1}^{{n}_{anc}} {2}^{i} {a}_{i} + q , \qquad ( 26 )$$

The isometry as shown in the plot 200 in FIG. 2 may act on a physical qubit and a χ=7 dimensional ancilla, transforming the state |00 [symbol] into a superposition of |11 [symbol] and |60 [symbol] , the state |10 [symbol] into |00 [symbol] , and so on. Additionally, the isometry in the plot 200 of FIG. 2 may be undefined when acting on states with |q=1 [symbol] in accordance with the sequential preparation scheme, but may take arbitrary ancilla states as inputs. Because of the isometry property, the nonzero elements of the operation may be, according to some example embodiments, the only elements that need to be accounted for when matching to a unitary, and therefore it need not be necessary to distinguish between zero elements and undefined elements.

As a first step in the compilation portion of the method, the isometries may be “cleaned” from the classical model in order to remove noise at the level of the classical optimization tolerance, otherwise effort may be expended attempting to compile this noise into quantum operations that will not improve the fidelity of the calculation. As such, a filter may be implementing on the MPS to remove elements below some tolerance level ε. According to some example embodiments, the filtering may be performed by using MPS compression to find the MPS with specified resources (e.g., restricted bond dimension χ) |ϕ [symbol] that is closest in the L₂-norm to a target MPS |ψ [symbol] that has higher resource requirements (χ′). While, according to some example embodiments, this may be optimally done variationally, in some example embodiments, a simple and practical method for performing this operation can be to use local SVD (singular value decomposition) compression, in which the MPS tensor of the orthogonality center A^{[i]} may be decomposed by the SVD as

$$\begin{matrix}{A}_{αβ}^{[ i ] ji} \to {\sum }_{μ} {U}_{( α ji ) μ} {S}_{μ} {V}_{μβ} , & ( 27 ) \\ {A}_{αβ}^{[ i ] ji} \to {\sum }_{μ} {U}_{αμ} {S}_{μ} {V}_{μ ( ji β )} , & ( 28 )\end{matrix}$$

where the upper expression may be for a right-moving update and the lower may be for a left-moving update. The bond dimension may be truncated by keeping only the χ largest singular values, or a new bond dimension may be determined implicitly through a singular value cutoff ε as

$$1 - {\sum }_{μ = 1}^{χ} {S}_{μ}^{2} / {\sum }_{μ} {S}_{μ}^{2} < ɛ . \qquad ( 29 )$$

When the MPS tensor is the orthogonality center, this condition may be equivalent to an L₂-norm optimization of the full wavefunction. Replacing A^{[i]} by the truncated U for a right-moving update or by V for a left-moving update may be performed and then the truncated SV or US may be contracted into the neighboring tensor to complete the local optimization. Sweeping the optimization across all tensors may also therefore complete the filtering step. According to some example embodiments, since the optimization may only interact with the parameters of a single MPS tensor at a time, the optimization may not be guaranteed to be globally optimal. However, this simple procedure works well in practice with reasonable results. As an additional benefit, ending the optimization by applying the update Eq. (27) and replacing the MPS tensor A^{[i]} with U for each tensor, may place the MPS in left-canonical form, from which the isometries for sequential preparation can be constructed from the tensor elements.

Additionally, the conversion of an MPS into left-canonical form may use the gauge freedom inherent in MPSs, namely that any invertible matrix [symbol] and its inverse can be placed between any two tensors of the MPS, i.e.,

[symbol]

^{[i],j}^{ᵢ}= [symbol] ^{[i],j}^{ᵢ} [symbol] , (30)

[symbol]

^{[i+1],j}^{ᵢ₊₁}= [symbol] ₋₁ [symbol] ^{[i+1],j}^{ᵢ₊₁} (31)

such that each of the tensors in the left-canonical MPS may satisfy the isometry constraint

$${\sum }_{α j} {L}_{αβ}^{[ i ] j} {L}_{{αβ}^{′}}^{[ i ] j ★} = {δ}_{{ββ}^{′}} , \qquad ( 32 )$$

without changing the overall quantum state. However, the constraint Eq. (32) may allow for the insertion of any unitary matrix and its inverse on either the left or right bond basis of an MPS tensor [symbol] ^{[i]j} without changing the state or the isometry conditions. According to some example embodiments, this freedom stems from the bond degrees of freedom being only used to mediate correlations between the physical degrees of freedom and not directly measured, and therefore have no preferred basis for representation. As such, this freedom to produce MPS models that are more amenable to compilation on a given target hardware may be leveraged. Just as with the ordinary gauge freedom of MPSs, a change of gauge may affect two neighboring MPS tensors at a time, and so an operation that may benefit one tensor may also affect its neighbors and so on down the network. Thus, the optimal choice of gauge may require a global optimization across all tensors. To utilize the ambiguity in the basis representation of the ancilla states, a procedure may be used that aids in compiling isometries for QAML models. The heuristic guiding the scheme can be to ensure that operations are as “diagonal” as possible, in the sense that qubits may preferentially remain in their same state rather than being swapped or mixed with other ancilla qubits. Operationally, in order to work only within the ancilla basis with freedom of representation, a matrix of overlaps may be defined as

$${M}_{αβ}^{[ i ]} = {\sum }_{j} {L}_{αβ}^{[ i ] j ★} {L}_{αβ}^{[ i ] j} , \qquad ( 33 )$$

which “integrates out” the physical qubit from the isometry used for sequential preparation, and therefore, according to some example embodiments, acts only in the ancilla space. A diagonal [symbol] may therefore be desired, which would preserve the individual ancilla basis states and reduce the number of quantum operations required. Since either the left or right basis of [symbol] may be changed at any one time, a possible option to increase its diagonal dominance through transformation of either the left or right basis may be to use the polar decomposition [symbol] → [symbol] or [symbol] → [symbol] with [symbol] unitary and [symbol] Hermitian and positive semidefinite. Using [symbol] ^{1/2} to transform the basis of L may transform [symbol] into [symbol] . However, this transformation may not preserve sparsity in L, which may lead to more complex operators in practice. Instead, the values of [symbol] first from the polar decomposition may be used to define a permutation of the ancilla basis states as, e.g.,

\tilde{L}_{α,argmax|} [symbol] _{_{:β}}_{|}^{[i],j}L_{αβ}^{[i]j} (34)

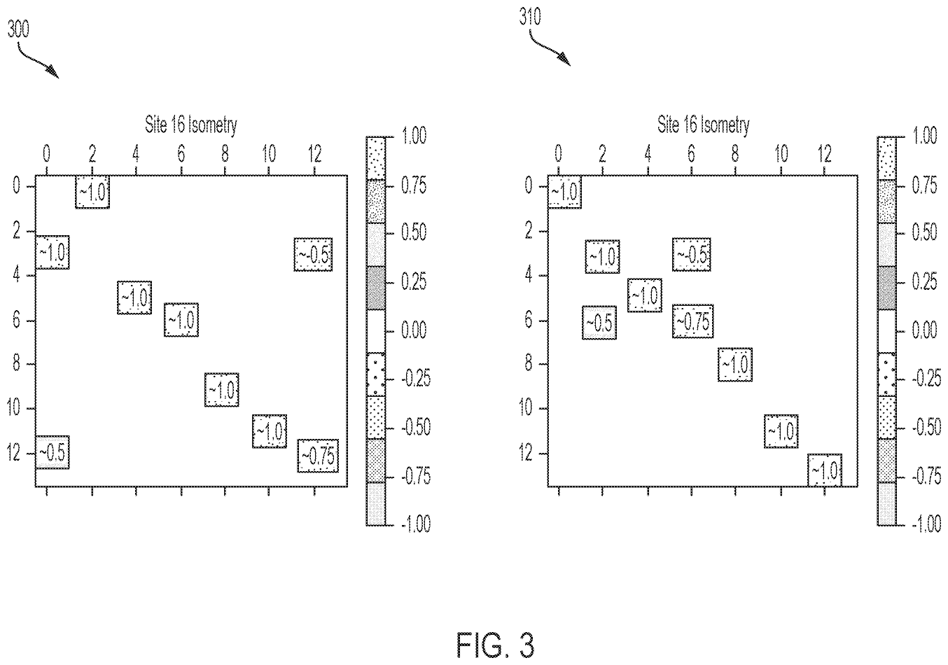

This operation may preserve sparsity, and may result in more diagonal operations in the ancilla degrees of freedom. An example of the isometries for a QAML model without this permutation procedure is shown in plot 300 of FIG. 3, and an example of the isometries for the same QAML model with this permutation procedure is shown in plot 310 of FIG. 3. As can be seen, a more diagonal isometry operator is realized in the plot 310 in the permutation of the basis states. More specifically, FIG. 3 shows example isometries for operations with χ=7 dimensional ancilla before, i.e., plot 300, and after, i.e., plot 310 applying the diagonal gauge transformation Eq. (34) to the right ancilla basis states.

The permutation operation Eq. (34) may be ambiguous whenever multiple elements of a column of [symbol] have the same absolute value. Since the sequential MPS preparation scheme may require that the ancilla start and end in the vacuum state, this may occur for tensors near the extremal values of the representation when an ancilla qubit is first utilized or an ancilla qubit is decoupled from the remaining qubits. In such cases, an alternate procedure may be employed to decide between permutations. First, all basis permutations may be enumerated resulting from these ambiguities for a given tensor [symbol] ^{[i],j}^{ᵢ} and associated isometries L̊^{(ζ)} may be constructed, in which ζ indexes permutations. To select a permutation, this operator may be conditioned to be as “diagonal” as possible, in the sense of minimizing the number of qubit operations being applied. A simple cost function, according to some example embodiments, may be constructed as follows: for each state indexed by the ancilla state α and the physical qubit q as above, convert the state index into its binary representation b, which effectively maps the ancilla state onto a collection of log₂χ qubits. As an example, the states of a four-dimensional ancilla and a single physical qubit can give the representations

index(|0,0 [symbol] )=0→(0,0,0), (35)

index(|0,1 [symbol] )=1→(0,0,1), (36)

index(|1,0 [symbol] )=2→(0,1,0), (37)

index(|1,1 [symbol] )=3→(0,1,1), (38)

.

.

., (39)

index(|3,1 [symbol] )=7→(1,1,1). (40)

A distance may then be calculated between two basis states (α,j) and (α′, j′) with respective binary representations b and b′ as [symbol] [(α, j), (α′, j′)]=(Σ_{μ}|b_{μ}−b′_{μ}|)². The term in parentheses counts the number of individual qubit “flips” required to convert one of the states into the other, and the square strongly penalizes multi-qubit coordinated flips. The cost function

[symbol]

_{ζ}=Tr(| [symbol] ^{(ζ)}| [symbol] ), (41)

may then be used in which [symbol] is the matrix with [symbol] [•, •] as elements and [symbol] ^{(ζ)}| is the matrix of absolute values of [symbol] ^{(ζ)}, to choose from between the [symbol] ^{(ζ)}.

As with the transformation of the MPS gauge to a mixed canonical form, a “right-moving” update may be implemented that permutes the right bond basis of a tensor [symbol] ^{[i]} and the left bond basis of [symbol] ^{[i 1]} and a “left-moving” update may be implemented that permutes the left bond basis of [symbol] ^{[i]} and the right bond basis of [symbol] ^{[i-1]}. When applied to all tensors, the MPS may be in the diagonal gauge, as it is the gauge which may enforce the isometries for state preparation to be as diagonal as possible (according to the particular cost functions). The MPS may still be in left-canonical form, and so the sequential preparation scheme may still hold. As such, the diagonal gauge may merely use the unitary freedom remaining in the left-canonical form to further optimize the state preparation procedure while maintaining sparsity. A single tensor may exist that is not optimized at a certain location k in the transformation to the diagonal gauge that may be referred to as the diagonality center, which may be analogous to the orthogonality center of mixed canonical form. While the location of the diagonality center can again be used as an optimization parameter, the diagonality center may be set to an isometry that is initially an identity matrix. Such an isometry may, according to some example embodiments, be introduced, if necessary, by padding the classical data vectors with a zero at location k. This is because the permutation to diagonal gauge can transform this identity isometry into a permutation matrix, which may be easier to compile with high fidelity, as opposed to a general, non-sparse isometry.

In addition to the permutation ambiguity, a sign ambiguity may also exist on each of the bond states of the isometry. Diagonal dominance may be used in fixing the sign ambiguity by reversing the sign of a column (row) if the element with magnitude above a certain threshold closest to the diagonal is negative during a right-moving (left-moving) update of the diagonal gauge, with the sign also being absorbed into the tensor to the right (left) of the one being optimized. Following transformation to diagonal gauge, the signs of all elements of the diagonality center (chosen, as above, to be a permutation operator) may be fixed to be positive by absorbing any negative signs into the nearest tensor that has elements of a mixed sign in the chosen bond direction.

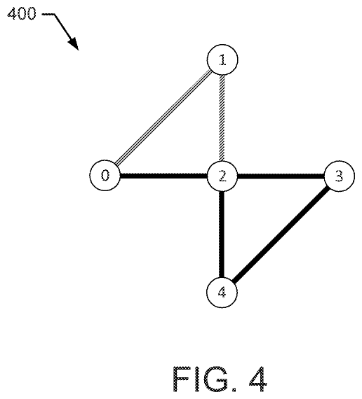

Following the fixing of gauge as described above, the isometries \hat{L}ᵢ may be transformed into operations to be performed on quantum hardware. The target hardware, according to some example embodiments, may have a collection of qubits laid out with a given topology and an allowed gate set of single-qubit rotations and entangling gates between pairs of qubits. According to some example embodiments, two-qubit gates may be subject to higher degrees of noise than single-qubit gates, and therefore higher-fidelity operations may be obtained by using a minimum number of two-qubit gates. As an example, a qubit/gate topology for an example NISQ hardware in the form of the IBMQ-X2 machine is shown in chart 400 of FIG. 4. As shown in the chart 400, the qubit layout (circles), controlled-NOT (CNOT) coupling topology (lines) are shown.

For this example device, the single-qubit gates are defined by

$${\hat{U}}_{3} ( θ , ϕ , λ ) = ( \begin{matrix}cos \frac{θ}{2} & - {e}^{i λ} sin \frac{θ}{2} \\ {e}^{i ϕ} sin \frac{θ}{2} & {e}^{i ( λ + ϕ )} cos \frac{θ}{2}\end{matrix} ) , \qquad ( 42 )$$

and the two-qubit gates are controlled-NOT (CNOT) gates, which are allowed only between qubits 0 and 2, 2 and 3, 3 and 4, or 2 and 4 as indicated by the solid lines in the chart 400 of FIG. 4. Also, an average error of the CNOT gates was measured to be ˜2.6%, while the error of the single-qubit gates was ˜0.15%. Hence, when compiling the isometries, it is beneficial to use as few gates as possible, and especially minimize the number of two-qubit gates.

In the compilation heuristic, possible unitaries may be enumerated by constructing a tree of potential circuit structures with continuous parameters to be optimized. The root node of the tree may include a single-qubit gate (such as the Û₃ gate in Eq. (42)) for each qubit. Each node in the tree may have a child node corresponding to the placement of an entangling gate in one of its allowed positions, and then single-qubit gates may be added to the qubits acted on by the entangling gate. According to some example embodiments, any circuit that can be constructed using the allowed entangling gates and single qubit rotations may correspond to a node in this tree. In order to select between nodes in the tree, a cost function

$$𝒞 ( \hat{U} , \hat{L} ) = {\sum }_{( i , j ) ∈ 𝒮} {\vert {U}_{ij} - {L}_{i , j} \vert}^{2} , \qquad ( 43 )$$

may be defined in which S denotes the set of indices such that the elements of the matrix representation of the isometry may be greater than some tolerance |L_{i,j}|>δ. Because of the isometry property of \hat{L} and the unitarity of the candidate gates Û, optimization may be performed, according to some example embodiments, only over the elements in S, which can reduce the computational complexity of the cost function. A particular unitary Û may be selected as being acceptable when the cost function falls below a specified tolerance. The optimization procedure may proceed by optimizing a root node (single-qubit gates) over parameters of the root node and checking the cost function, for example, against a threshold, to determine if an acceptable gate is found. If no acceptable gate is found, a queue of gates corresponding to adding an entangling gate and a pair of single-qubit gates to the root node in all allowed locations as described above may be formed. The gates of the queue may be optimized and their respective cost functions may be recorded. If no gate from this queue is acceptable, a priority queue may be formed by sorting the gates from this set according to their cost functions and then appending entangling gates and single-qubit rotations. In order to avoid an exponential growth of the number of search considerations, the number of gates forming the starting point of the priority queue (i.e., before appending new entangling gate and single-qubit rotations) may be limited to a fixed number. This number may be used as a convergence parameter, and may vary between optimization cycles. In this regard, according to some example embodiments, it may be useful to allow more gates in early optimization cycles where the operations involve fewer parameters and therefore optimization is faster, and then subsequently decrease the number of kept gates as the circuits become deeper. Additionally, according to some example embodiments, a gate-dependent heuristic function h may be added to the cost function when sorting gates to add to the priority queue. The gate-dependent heuristic function h may be used to account for, e.g., hardware-dependent noise.

The subroutine for the cost function may take as an input a vector of parameters θ, construct a matrix representation of the parameterized gate sequence

Û(θ)=\hat{M}_{N}_{_{G}}(θ_{N}_{_{G}}) . . . \hat{M}₁(θ₁), (44)

in which θᵢ is the vector of parameters used by gate i, and then evaluate the cost function Eq. (43). In this manner, analytic gradients of the cost function may also be obtained as elements of products of matrices. The cost function may be optimized using the BFGS (Broyden-Fletcher-Goldfarb-Shanno) method, and allow for multiple batches of input parameters with random variations added to avoid local minima. Additionally, according to some example embodiments, all of the isometries that result from the use of a real-valued quantum embedding map may be real, and therefore the analysis may be restricted to real-valued gates.

Accordingly, the single-qubit gates may be parameterized as y-rotations

$${\hat{R}}_{y} ( θ ) ≡ ( \begin{matrix}cos \frac{θ}{2} & - sin \frac{θ}{2} \\ sin \frac{θ}{2} & cos \frac{θ}{2}\end{matrix} ) , \qquad ( 45 )$$

which relate to the gates in Eq. (42) as \hat{R}_{y}(θ)=Û₃(θ, 0, 0), and CNOTs for the entangling gates. While there is no guarantee that there are not operations with fewer entangling gates that could be found using complex-valued gates, the reduction in the number of parameters when using real gates can significantly improve the optimization time.

The final optimization, according to some example embodiments, may introduce longer gate sequence “motifs” into the optimization alongside the native entangling gates. In particular, the two motifs that may be utilized are, for example, a two-qubit rotation gate

$$\hat{𝒮} ( θ , {θ}^{′} ) = ( \begin{matrix}cos \frac{( θ - {θ}^{′} )}{2} & 0 & 0 & sin \frac{( θ - {θ}^{′} )}{2} \\ 0 & cos \frac{( θ + {θ}^{′} )}{2} & sin \frac{( θ + {θ}^{′} )}{2} & 0 \\ 0 & - sin \frac{( θ + {θ}^{′} )}{2} & cos \frac{( θ + {θ}^{′} )}{2} & 0 \\ - sin \frac{( θ - {θ}^{′} )}{2} & 0 & 0 & cos \frac{( θ - {θ}^{′} )}{2}\end{matrix} ) , \qquad ( 46 )$$

which is allowed between any two qubits that have CNOT connectivity, and a version of the Ŝ gate referred to as [symbol] that may be controlled on a third qubit. In this regard, the former gate can be compiled using two CNOTs using the ansatz sequence shown in Eq. (47)
and the latter gate with control on qubit c and the operation Ŝ applied to qubits q₁ and q₂ can be constructed using

$${\hat{ℱ}}_{c ; {q}_{1} {q}_{2 }} ( θ , {θ}^{′} ) = CNOT ( c , {q}_{2} ) CNOT ( c , {q}_{1} ) {\hat{𝒮}}_{{q}_{1} {q}_{2}} ( - \frac{θ}{2} , - \frac{{θ}^{′}}{2} ) \times CNOT ( c , {q}_{2} ) CNOT ( c , {q}_{1} ) {\hat{𝒮}}_{{q}_{1} {q}_{2}} ( \frac{θ}{2} , \frac{{θ}^{′}}{2} ) . \qquad ( 48 )$$

Hence, Ŝ gates may require 2 CNOTs for compilation and [symbol] gates may require 8 CNOTs for compilation. In this regard, both of these gates were identified from experiments with the greedy optimization procedure described above using only CNOTs, and their direct inclusion into the optimization enables more rapid convergence. As these gates require multiple entangling gates, a heuristic penalty function h may be introduced into the cost function for ordering the next priority queue to ensure that they are not chosen over shorter gates with a similar cost function. The choice of this penalty function and the optimization of the penalty function may be problem-specific. Additionally, the use of multi-qubit controlled gates may be penalized through the choice of the cost function Eq. (41) for choosing the permutation to diagonal gauge. The choice of a cost function of 4 or 8 for a gate requiring two and three bit flips may be in rough accordance with the number of CNOTs required for Ŝ and [symbol] , respectively.

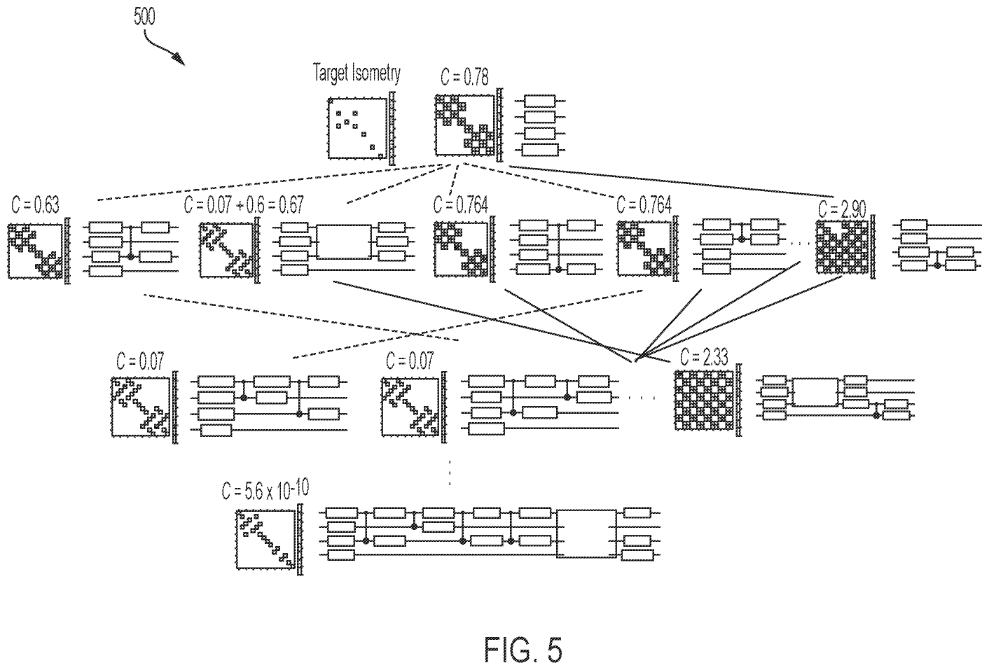

An application of the example procedure to the isometry shown in the plot 310 of FIG. 3 is shown in the chart 500 in FIG. 5. In this regard, the chart 500 illustrates an example greedy compilation procedure. Example gates represented as circuits and matrix plots resulting from applying the greedy compilation procedure to the isometry are shown in the upper left (same isometry as in the plot 310 of FIG. 3). The starting ansatz may be a single-qubit rotation on each qubit, given in the top center of the chart 500. The next row down from the top shows the gates resulting from adding a single entangling gate to this ansatz, ordered left to right by their cost functions C. A constant penalty 0.6 may be added to the cost function for use of a [symbol] gate in ordering the priority queue, which may result in the given ordering. The gates indicated by lighter gray lines denote those passed to the next level of optimization. This procedure may terminate in the gate shown at the bottom of the chart 500 with the given cost function tolerance of 5×10⁻⁴.

Accordingly, cost function penalties may be provided of 0.6 and 0.2 for [symbol] and Ŝ gates, respectively. Additionally, a cost function tolerance of 5×10⁻⁴ may be used, and the 4 lowest cost gates may be kept to generate the priority queue from the first optimization and the 2 lowest-cost gates on subsequent optimizations. The successive rows show the optimized gates resulting from adding a single entangling gate to the ansatz resulting from the last round of optimization, starting with a single-qubit rotation on each qubit (top center of the chart 500). Again, the light gray lines show the gates which are kept to form the new priority queue. Here and throughout, the quantum circuits may be ordered with the physical (i.e. readout) qubit on the top line and the ancilla qubits in increasing order on lower lines.

Following an optimization in which Ŝ or [symbol] gates may be used, the “raw” circuit containing these parameterized gates may then be compiled into CNOTs using Eqs. (47) and (48), products of single-qubit rotations may be collected together, and then optimization passes may be run to determine if single-qubit gates with rotations smaller than a certain threshold can be removed without affecting the cost function. According to some example embodiments, no cost function penalty may be applied when an Ŝ or [symbol] gate brings the cost function below its desired tolerance, as in the last step of the optimization shown in the chart 500 of FIG. 5, but may, for example, only be used for ordering the priority queue when no gates meet the cost function tolerance.

Several methods for the compilation of isometries may be considered, such as, for example, the algorithms that underlie the implementation in QISKIT®, e.g., an open-source software development kit. In the approach, for example, the matrix representation of the isometry may be decomposed, e.g., a single column at a time or by the cosine-sine decomposition, and the resulting decompositions may be expressed in terms of multi-qubit controlled operations, which may also be decomposed into a target gate set using, for example, known representations.

The approaches may be constructive, and may therefore find decompositions of any isometry in principle. However, in some instances the approached may not be designed to find the most efficient representation by some metric, e.g., the number of entangling gates. Further, as described above, the use of such algorithms may require an “isometric completion” in the case that the bond dimension χ is not a power of 2, and may expend additional resources compiling noise in the isometries. Additionally, some special purpose methods may also be leveraged that have been developed for compiling permutation gates, which have been shown to outperform some generic algorithms in some cases. According to some example embodiments, this example method may use a reversible logic synthesis to map the permutation into a reversible circuit including single-target gates, and these single-target gates may then be compiled into networks of CNOTs, Hadamard gates, and \hat{R}₂(θ)=|0 [symbol] [symbol] 0|+e^{iθ}|1 [symbol] [symbol] 1| rotations.

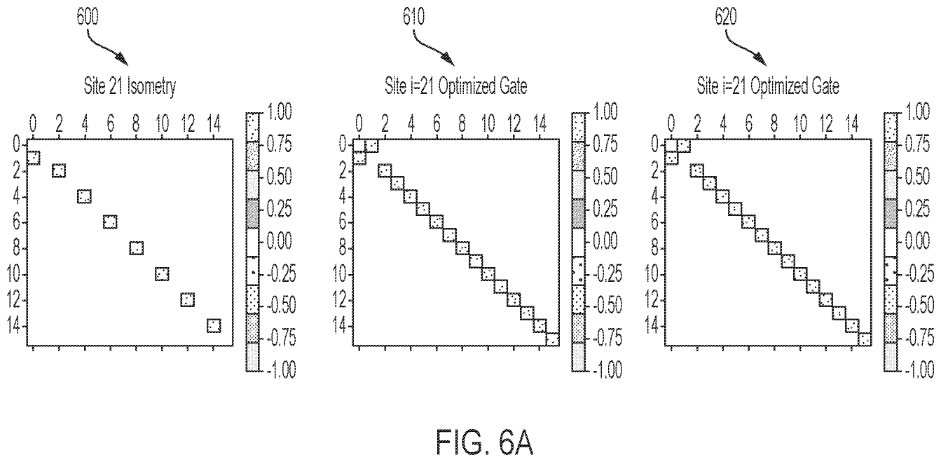

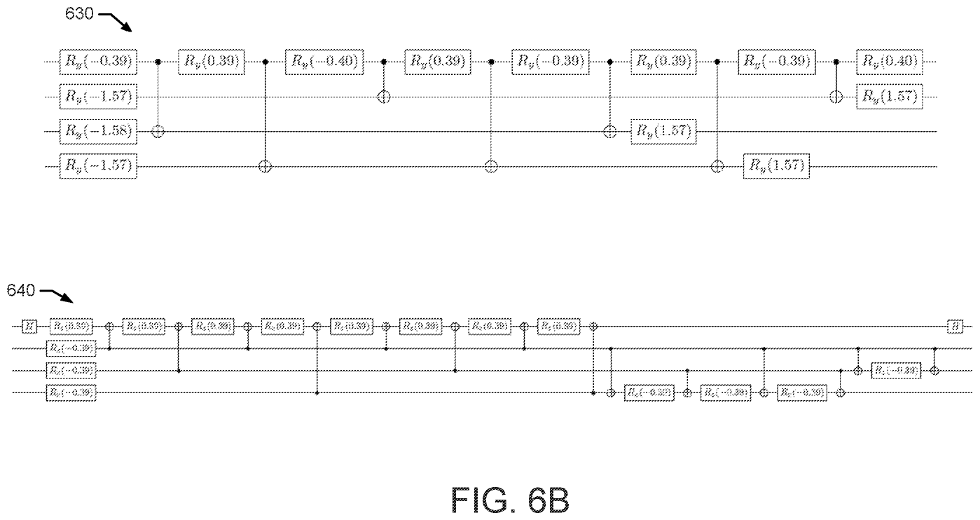

In order to compare the methods with the generic, constructive method for compiling isometries, the isometry in the plot 310 of FIG. 3 and the chart 500 of FIG. 5 may be considered. As noted above, in order to utilize the generic methods, this isometry can be mapped into a complete isometry over a set of qubits, which requires definition of the action of the isometry on the state in which the ancilla qubits are all in the state |1 [symbol] . This state may have been left unconstrained by the optimization procedure. For simplicity, the “isometric completion” may be used in which the operator takes this state to itself without modifying the state of the physical qubit. Using the iso method of the QuantumCircuit class from QISKIT® implementing the generic methods on the unconstrained ibmq_qasm simulator hardware topology can produce a gate representation with 122 CNOTs at optimization_level 0, and 120 CNOTs at optimization_level 3. The greedy compilation procedure presented herein, and variations thereof, can achieve a representation with a cost function error of 5.6×10¹⁰ with an order of magnitude fewer entangling gates for this particular isometry. As a point of comparison for the specialized methods for permutation gates studied in M. Soeken, F. Mozafari, B. Schmitt, and G. De Micheli, in 2019 Design, Automation & Test in Europe Conference & Exhibition (IEEE, 2019) pp. 1349-1354 (hereinafter “Soeken”) and herein incorporated by reference in its entirety, the isometry shown in plot 600 of FIG. 6A may be considered. A permutation on the space acted upon is provided, which can be represented by a family of “unitary completions.” Unitary completion may be considered in which the ancilla qubits are left unchanged by the permutation, as shown in plot 620 of FIG. 6A. The result of applying the greedy compilation procedure is given in matrix form in plot 610 of FIG. 6A, and in quantum circuit form 630 of FIG. 6B. This gate requires 7 CNOTs, and has a cost function error of ˜2×10⁻¹⁵. The result of applying the methods of Soeken are shown in plot 620 of FIG. 6A and quantum circuit form 640 of FIG. 6B. In this regard, the gate requires 14 CNOT operators. In general, the greedy compilation procedure described herein finds comparable or better gates for isometries corresponding to near-diagonal permutations compared to using the methods of Soeken with the straightforward unitary completion given above. Additionally, the greedy compilation procedure may be designed for isometries and therefore generally does not produce permutation operators on the entire space at the end of optimization. In other words, the optimized gate may be a permutation in the space spanned by the isometry, but the full unitary may not be a permutation.

Following from the description above, an exactly solvable benchmark model can be defined. As an exactly solvable benchmark, an NIPS Born machine may be considered that encodes the probability distribution of classical discrete data vectors x, χᵢ∈{0, 1}∀ᵢ. A simple nontrivial situation to consider may be when the data vectors consist of all zeros except for a single 1, closely related to the canonical bars and stripes (BAS) dataset. The probability that the 1 resides at location i may be denoted as pᵢ, with Σᵢ₌₀^{N-1}pᵢ=1. It can be shown that this data can be represented exactly as a bond dimension 2 NIPS Born machine with tensors

A₀₀^{[0]0}=1,A₀₁^{[0]1}=e^{iϕ}^{₀}\sqrt{p₀}, (49)

A₀₀^{[j]0}=1,A₀₁^{[j]1}=e^{iϕ}^{ⱼ}\sqrt{pⱼ},A₁₁^{[j]0}=1 (50)

A₁₀^{[N-1]0}=1,A₀₀^{[N-1]1}=e^{iϕ}^{_{N−1}}\sqrt{p_{N-1}}, (51)

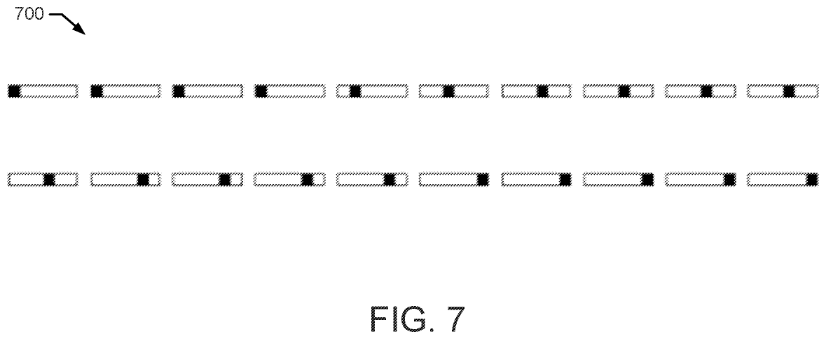

and with the {ϕⱼ} denoting arbitrary phases. The presence of a large number of arbitrary phases may be a generic feature of TN models for generative applications, and, since the square of the wavefunction can be used to generate classical data samples, the phase structure of the wavefunction may be generally under-constrained. This in turn implies that TN models can have some flexibility over the particular gate set used to entangle the physical qubits to the ancillae without affecting the sampling outcomes. The exactly solvable model encapsulated by Eqs. (49)-(51) may be a useful benchmark both because it is a simple nontrivial example of a sequentially preparable QAML model, involving a single ancilla qubit, and because it can be exactly solved for any classical data vector length and probabilities P. An example dataset 700 for P=(⅕; 1/20; 1/20; ¼; ⅕; ¼) is given in the FIG. 7 as an exactly solvable MPS generative model with six-dimensional probability.

In order to convert this generic MPS into a sequential qubit preparation scheme the MPS can be placed into left-canonical form. Since the bond dimension is known, this can be done in terms of the QR decomposition. For simplicity of exposition, all phases ϕⱼ=0 may be taken, although this condition may be relaxed. Performing the QR decomposition on the first tensor, it can be determined that

$$\begin{matrix}{A}^{[ 0 ]} = ( \begin{matrix}1 & 0 \\ 0 & \sqrt{{p}_{0}}\end{matrix} ) & ( 52 ) \\ \to QR = ( \begin{matrix}1 & 0 \\ 0 & \sqrt{\frac{{p}_{0}}{\vert {p}_{0} \vert}}\end{matrix} ) ( \begin{matrix}1 & 0 \\ 0 & \sqrt{{p}_{0}}\end{matrix} ) , & ( 53 ) \\ ⇒ {L}^{[ 0 ]} = ( \begin{matrix}1 & 0 \\ 0 & \sqrt{\frac{{p}_{0}}{\vert {p}_{0} \vert}}\end{matrix} ) , & ( 54 ) \\ {A}_{00}^{[ 1 ] 0} = 1 , {A}_{01}^{[ 1 ] 1} = \sqrt{{p}_{1}} , {A}_{11}^{[ 2 ] 0} = \sqrt{{p}_{0}} . & ( 55 )\end{matrix}$$

Reshaping the second tensor and decomposing, it can be found that

$$\begin{matrix}{A}_{( α i ) β}^{[ 1 ]} = ( \begin{matrix}1 & 0 \\ 0 & \sqrt{{p}_{1}} \\ 0 & \sqrt{{p}_{0}} \\ 0 & 0\end{matrix} ) & ( 56 ) \\ \to QR = ( \begin{matrix}1 & 0 \\ 0 & \sqrt{\frac{{p}_{1}}{{p}_{0} + {p}_{1}}} \\ 0 & \sqrt{\frac{{p}_{0}}{{p}_{0} + {p}_{1}}} \\ 0 & 0\end{matrix} ) ( \begin{matrix}1 & 0 \\ 0 & \sqrt{{p}_{0} + {p}_{1}}\end{matrix} ) , & ( 57 ) \\ ⇒ {L}_{00}^{1 [ 0 ]} = 1 , {L}_{01}^{[ 1 ] 1} = \sqrt{\frac{{p}_{1}}{{p}_{0} + {p}_{1}}} , {L}_{11}^{[ 1 ] 0} = \sqrt{\frac{{p}_{0}}{{p}_{0} + {p}_{1}}} . & ( 58 )\end{matrix}$$

This generalizes to

$${L}_{00}^{[ j ] 0} = 1 , {L}_{01}^{[ j ] 1} = \sqrt{\frac{{p}_{j}}{{\sum }_{i \leq j}}} , {L}_{11}^{[ f ] 0} = \sqrt{\frac{{\sum }_{i < j} {p}_{i}}{{\sum }_{i \leq j} {p}_{i}}} , \qquad ( 59 )$$

with the last tensor being

$${L}_{10}^{[ N - 1 ] 0} = \sqrt{{\sum }_{i < N - 1} {p}_{i} ,} {L}_{00}^{[ N - 1 ] 1} = \sqrt{{p}_{N - 1}} , \qquad ( 60 )$$

These left-canonical tensors can be reshaped to correspond to isometries acting on a single physical qubit |i_{q} [symbol] , and an ancilla qubit |α_{α} [symbol] . The process may start from the N^{th} tensor, where both the qubit and ancilla are in the state 0. The isometry is

\hat{L}_{N-1}=(\sqrt{1−p_{N-1}}|1_{α}0_{q} [symbol] +\sqrt{p_{N-1}}|0_{α}1_{q} [symbol] ) [symbol] 0_{α}0_{q}|. (61)

Following this, the physical qubit can be measured in the computational basis and its outcome (classically) stored, and then the physical qubit may be returned to the state |0_{q} [symbol] . The procedure of acting with isometries may then be repeated, measuring the physical qubit, classically recording its output, and returning the physical qubit to 0, using the isometries

$${\hat{L}}_{j} = \vert {0}_{a} {0}_{q} 〉 〈 {0}_{a} {0}_{q} \vert + ( \sqrt{\frac{{p}_{j}}{{\sum }_{i \leq j} {p}_{i}}} \vert {0}_{a} {1}_{q} 〉 + \sqrt{\frac{{\sum }_{i < j} {p}_{i}}{{\sum }_{i \leq j} {p}_{i}}} \vert {1}_{a} {0}_{q} 〉 ) 〈 {1}_{a} {0}_{q} \vert . \qquad ( 62 )$$

It is noteworthy that Eq. (62) also holds for the final site, j=0, and produces an unentangled ancilla in the state |0_{α} [symbol] . With these operators in hand, the arbitrary phases on the elements may be reinserted resulting in the state |1_{q} [symbol] , yielding

$$\begin{matrix} {\hat{L}}_{N - 1} = ( \sqrt{1 - {p}_{N - 1}} \vert {1}_{a} {0}_{q} 〉 + {e}^{i {ϕ}_{N - 1}} \sqrt{{p}_{N - 1}} \vert {0}_{a} {1}_{q} 〉 ) 〈 {0}_{a} {0}_{q} \vert , & ( 63 ) \\ {\hat{L}}_{j} = \vert {0}_{a} {0}_{q} 〉 〈 {0}_{a} {0}_{q} \vert + ( {e}^{i {ϕ}_{j}} \sqrt{\frac{{p}_{j}}{{\sum }_{i \leq j} {p}_{i}}} \vert {0}_{a} {1}_{q} 〉 + \sqrt{\frac{{\sum }_{i < j} {p}_{i}}{{\sum }_{i \leq j} {p}_{i}}} \vert {1}_{a} {0}_{q} 〉 ) 〈 {1}_{a} {0}_{q} \vert . & ( 64 )\end{matrix}$$

Accordingly, there is a “natural” unitary completion of the operators in Eq. (64) given by

$${\hat{U}}_{j} = \vert {0}_{a} {0}_{q} 〉 〈 {0}_{a} {0}_{q} \vert + \vert {1}_{a} {1}_{q} 〉 〈 {1}_{a} {1}_{q} \vert + ( {e}^{i {ϕ}_{j}} \sqrt{\frac{{p}_{j}}{{\sum }_{i \leq j} {p}_{i}}} \vert {0}_{a} {1}_{q} 〉 + \sqrt{\frac{{\sum }_{i < j} {p}_{i}}{{\sum }_{i \leq j} {p}_{i}}} \vert {1}_{a} {0}_{q} 〉 ) 〈 {1}_{a} {0}_{q} \vert + ( \sqrt{\frac{{\sum }_{i < j} {p}_{i}}{{\sum }_{i \leq j} {p}_{i}}} \vert {0}_{a} {1}_{q} 〉 - {e}^{- i {ϕ}_{j}} \sqrt{\frac{{p}_{j}}{{\sum }_{i \leq j} {p}_{i}}} \vert {1}_{a} {0}_{q} 〉 ) 〈 {0}_{a} {1}_{q} \vert , \qquad ( 65 )$$

in which the state |1_{α}1_{q} [symbol] that is never populated under ideal operation, may be left unchanged and the action on the, also ideally unpopulated, state may be determined by orthogonality. Written in the basis representation, {|0_{α}0_{q} [symbol] , |0_{α}1_{q} [symbol] |1_{α}0_{q} [symbol] |1_{α}1_{q} [symbol] }, it may be determined that

$$[ {\hat{U}}_{j} ] = ( \begin{matrix}1 & 0 & 0 & 0 \\ 0 & cos {θ}_{j} & {e}^{i {ϕ}_{j}} sin {θ}_{j} & 0 \\ 0 & - {e}^{- i {ϕ}_{j}} sin {θ}_{j} & cos {θ}_{j} & 0 \\ 0 & 0 & 0 & 1\end{matrix} ) , \qquad ( 66 )$$

in which

$$cos {θ}_{j} = \sqrt{\frac{{\sum }_{i < j} {p}_{i}}{{\sum }_{i \leq j} {p}_{i}}}$$

and therefore

$$sin {θ}_{j} = \sqrt{\frac{{p}_{j}}{{\sum }_{i \leq j} {p}_{i}}} .$$

This gate may have a natural interpretation as a rotation within the subspace of a single quantum of excitation shared between the qubit and ancilla, with the rotation angle set by the classical data vector probabilities (for pⱼ→0, θⱼ→0 and Eq. (66) becomes the identity). An analogous unitary completion for the isometry \hat{L}_{N-1} may be given by

$${\hat{U}}_{N - 1} = ( cos {θ}_{N - 1} \vert {0}_{a} {1}_{q} 〉 + {e}^{i {ϕ}_{N - 1}} sin {θ}_{N - 1} \vert {0}_{a} {1}_{q} 〉 ) 〈 {0}_{a} {0}_{q} \vert + ( - {e}^{i {ϕ}_{N}} sin {θ}_{N - 1} \vert {1}_{a} {0}_{q} 〉 + cos {θ}_{N - 1} \vert {0}_{a} {1}_{q} 〉 ) 〈 {0}_{a} {1}_{q} \vert + ( {e}^{i {ϕ}_{N}} sin {θ}_{N - 1} \vert {1}_{a} {1}_{q} 〉 + cos {θ}_{N - 1} \vert {0}_{a} {0}_{q} 〉 ) 〈 {1}_{a} {0}_{q} \vert + ( - {e}^{i {ϕ}_{N - 1}} sin {θ}_{N - 1} \vert {0}_{a} {0}_{q} 〉 + cos {θ}_{N - 1} \vert {1}_{a} {1}_{q} 〉 ) 〈 {1}_{a} {0}_{q} \vert . \qquad ( 67 )$$

From a gate-based perspective, the operators in Eqs. (66) with ϕ=−π/2 may be described by the Fermionic Simulation, or fSim^{(θ, φ)} gate, with φ=0 and θ=θⱼ, which has been demonstrated in gmon qubits. Alternatively, the operators may be a one-parameter generalization of the iSWAP gate. The unitary completion Ûⱼ at ϕⱼ=0 may be given by Ŝ(θⱼ, θⱼ) in the notation of Eq. (46), and so for the gate set employed by the IBMQ processors, the shortest decomposition for Uⱼ is given by Eq. 47. While in some alternative hardware platforms, such as those employing tunable qubits, iSWAP gates can be implemented natively, but partial iSWAPs may still require decomposition. The operation Eq. (66) may be generated by the effective Hamiltonian

[symbol]

ⱼθⱼ(\hat{σ}_{q}⁺\ddot{σ}_{α}⁻+\ddot{σ}_{q}⁻\hat{σ}_{α}⁺), (68)

for “unit time” in the sense that

Ûⱼ=exp(−i [symbol] ⱼ), (69)

when ϕⱼ=π/2. This gate may be readily achieved in trapped ion-based quantum computers using an equally weighted combination of XX and YY Mølmer-Sorenson gates, as well as a variety of other platforms implementing XY effective spin-spin interactions. Additionally, the “data angle” θⱼ may have a natural interpretation as an ersatz “evolution time” in this perspective.

Also, the freedom in representation of the bond basis may manifest itself in this exactly solvable example. Namely, the predictions of the model Eq. (49)-(51) may be unchanged if the roles of the |0_{α} [symbol] and |1_{α} [symbol] ancilla states are reversed in all but the first and last steps of preparation (using the unitary freedom exploited in the transformation to diagonal gauge discussed above). In this case, the isometries become

$$\begin{matrix} {\hat{L}}_{N - 1} = ( \sqrt{1 - {p}_{N - 1}} \vert {0}_{a} {0}_{q} 〉 + {e}^{i {ϕ}_{N - 1}} \sqrt{{p}_{N - 1}} \vert {1}_{a} {1}_{q} 〉 ) 〈 {0}_{a} {0}_{q} \vert , & ( 70 ) \\ {\hat{L}}_{j} = \vert {1}_{a} {0}_{q} 〉 〈 {1}_{a} {0}_{q} \vert + ( {e}^{i {ϕ}_{j}} \sqrt{\frac{{p}_{j}}{{\sum }_{i \leq j} {p}_{i}}} \vert {1}_{a} {1}_{q} 〉 + \sqrt{\frac{{\sum }_{i < j} {p}_{i}}{{\sum }_{i \leq j} {p}_{i}}} \vert {0}_{a} {0}_{q} 〉 ) 〈 {0}_{a} {0}_{q} \vert . & \begin{matrix}( 71 ) \\ ( 72 )\end{matrix}\end{matrix}$$

The natural unitary completions of these isometries can take the matrix representation

$$[ {\hat{\tilde{U}}}_{j} ] = ( \begin{matrix}cos {θ}_{j} & 0 & 0 & - {e}^{- i {ϕ}_{j}} sin {θ}_{j} \\ 0 & 1 & 0 & 0 \\ 0 & 0 & 1 & 0 \\ {e}^{i {ϕ}_{j}} sin {θ}_{j} & 0 & 0 & cos {θ}_{j}\end{matrix} ) , \qquad ( 73 )$$

and therefore may be described by Ŝ(−θⱼ, θⱼ) at ϕⱼ=0, and can be generated by the effective Hamiltonian

[symbol]

=θⱼ(\acute{σ}_{q}⁺\acute{σ}_{α}⁺+\hat{σ}_{q}⁻\hat{σ}_{α}⁻), (74)

at ϕ=π/2.

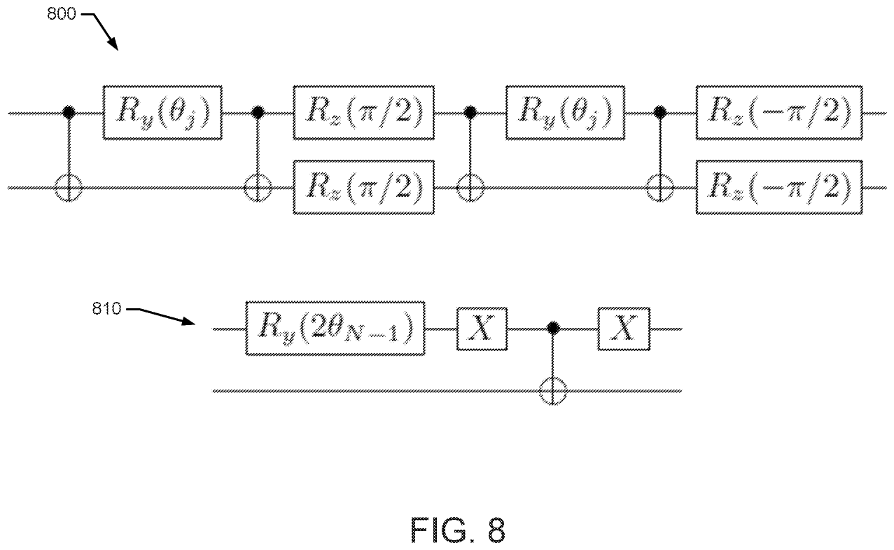

The application of the example methods described herein to the exactly solvable benchmark will now be described using the probabilities=(8/31; 18/31; 5/31). As a point of comparison, a “hand compiled” version of the unitary completed isometries Eqs. (65) and (67) may be considered. Taking ϕ=0, the gates can be complied using the circuits 800 and 810 shown in FIG. 8. Circuit 800 may be a circuit decomposition for Uⱼ of Eq. (65) and the circuit 810 may be a circuit decomposition of the U_{N-1} of Eq. (67). These circuit decompositions may be based on a gate set of single qubit rotations and CNOTs. In circuits 800 and 810, the upper line may be the physical (sampled) qubit and the lower line may be the ancilla.

However, it is additionally noteworthy that with the assumption that the physical qubit starts in the state |0_{q} [symbol] , the first CNOT in circuit 800 is the identity, and therefore it can be neglected, leading to a circuit with three CNOTs.

Additionally, results for the exactly solvable benchmark model running on cloud-based NISQ hardware can be provided, using IBM® devices as an example. The current IBM® hardware does not allow measurement and reinitialization during an experimental run, and therefore the sequential preparation schemes may not be directly implemented on these devices. However, the generative models can be tested by implementing the gates Ûⱼ of the sequential preparation scheme on a register of (N+1) qubits prepared in the |0 . . . 0 [symbol] state, coupling each physical qubit to the same ancilla in order from (N−1) down to 0. This procedure may be limited by the number of available qubits and their connectivity to a single ancilla qubit. However, for devices with a cross-shaped topology, such as the IBMQ-X2, up to 4 qubits may be coupled to a central ancilla qubit, and for devices with a T-shaped topology, such as the Vigo, up to 3 qubits can be coupled to a single ancilla.

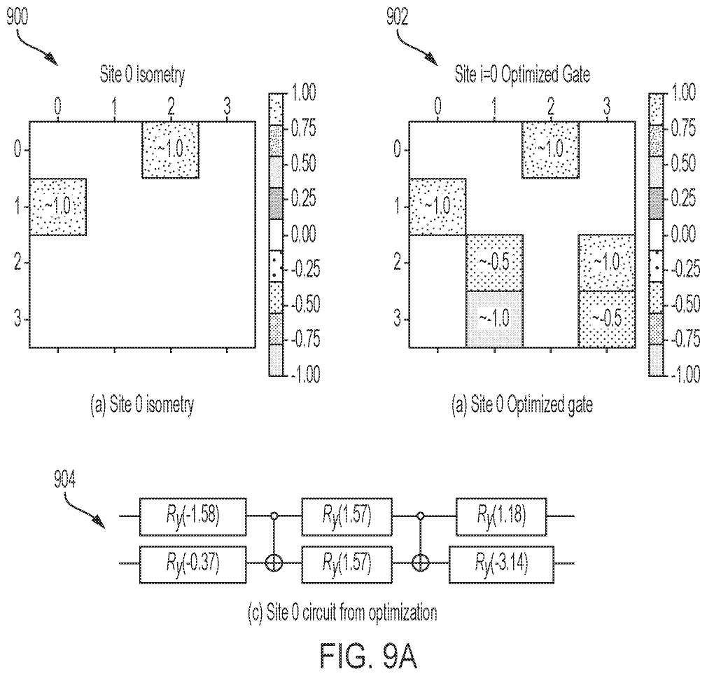

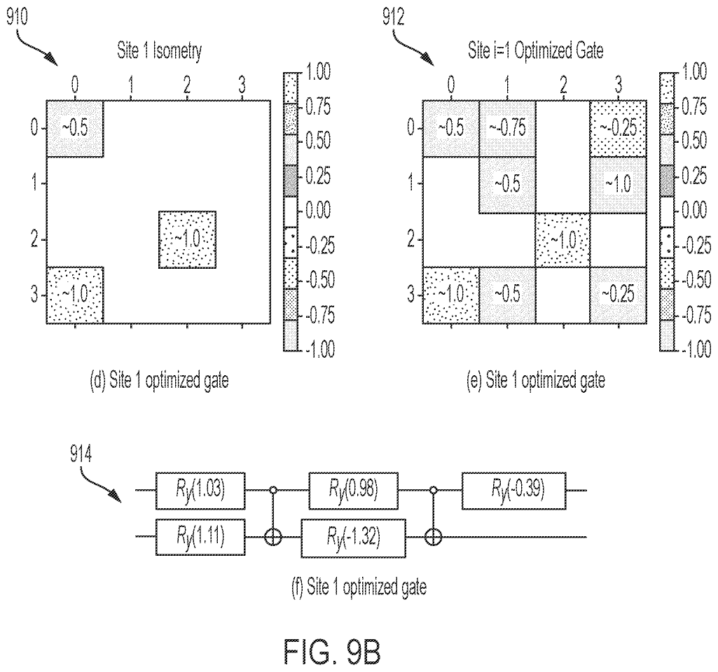

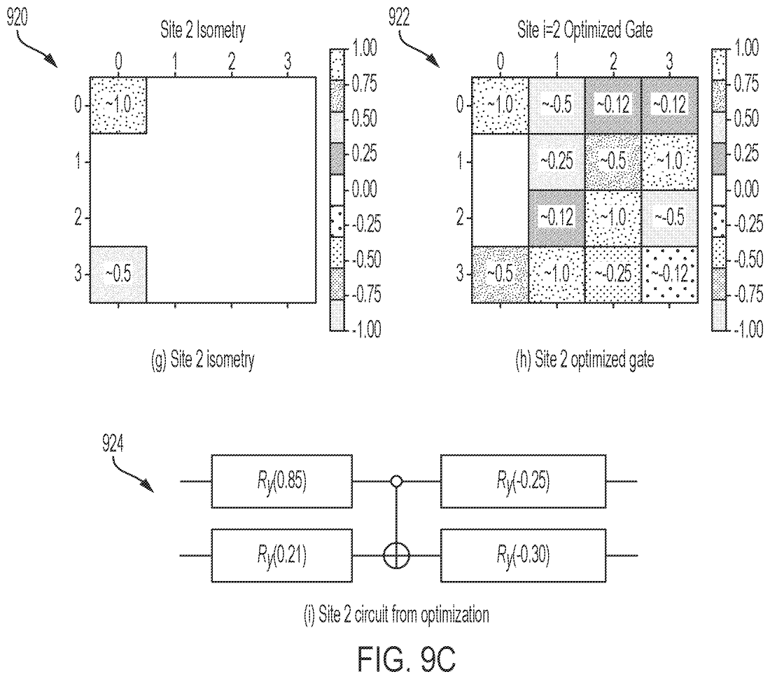

To demonstrate the methods to this benchmark case, an χ=2 Born machine may be trained using the single-site gradient descent described above and it may be compiled into gates using the procedures with the diagonality center at 1 and a greedy optimization tolerance of 5×10₋₄. The physical indices of the MPS tensors may be referred to as sites. The results of this procedure are shown in FIGS. 9A-9C for the exactly solvable Born Machine benchmark isometries. FIG. 9A shows plot 900 for the site 0 isometry, plot 902 for the site 0 optimized gate, and circuit 904 as the site 0 circuit from the optimization. FIG. 9B shows plot 910 for the site 1 isometry, plot 912 for the site 1 optimized gate, and circuit 914 as the site 1 circuit from the optimization. FIG. 9C shows plot 920 for the site 2 isometry, plot 922 for the site 2 optimized gate, and circuit 924 as the site 2 circuit from the optimization. In this regard, plots 900, 910, and 920 may be the isometries output from the classically trained model, plots 902, 912, and 922 may be matrix plots of the unitaries output by the greedy compilation procedure, and circuits 904, 914, and 924 may be circuit representations of the optimized unitaries.

The final cost functions for sites 0, 1, and 2 are 6.7×10⁻⁹, 7.3×10⁻¹⁰, and 2.0×10⁻⁹, respectively. The obtained quantum circuits, in this example, are substantially different than those obtained by hand-compilation of the “natural” unitary completion, but are still of very high fidelity in the space spanned by the isometry. In addition, the gates for sites 0 and 1 are shallower than the hand-compiled gate, which may be anticipated based on known optimality results for two-qubit gates.

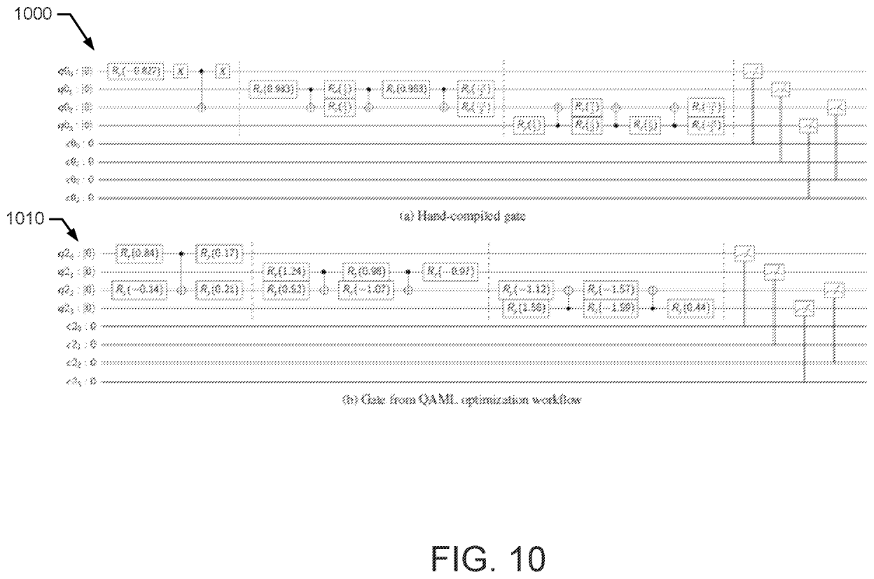

Utilizing this approach for the exactly solvable Born Machine model with the probability vector given above, the circuits may be determined shown in the hand-compiled circuit 1000 and the circuit from the QAML optimization 1010 of FIG. 10. Here, the physical qubits (those that are sampled to obtain output classical data vectors) are assigned to be qubits 0, 1, and 3, and the ancilla is qubit 2. In this regard, the circuit 1000 is for the hand-compiled circuits from the circuit decompositions shown in FIG. 8, and the circuit from the QAML optimization 1010 is from the circuits shown FIG. 9. Referencing the gates of FIG. 10, the dashed vertical lines demarcate the circuits corresponding to the individual sites of the Born machine, but are inessential and neighboring single-qubit rotations can be joined for increased efficiency.

As metrics for assessing the performance of the QAML models generated in accordance with various example embodiments, the raw experimental counts used to infer measurement probability distributions and a convex version of the Kullback-Leibler (KL) divergence between the ideal (p_{T}) and estimated p_{N}) distributions may be utilized,

$$KL ( {p}_{T} , {p}_{N} ) = \{ \begin{matrix}{p}_{T} [ log ( \frac{{p}_{T}}{{p}_{N}} ) - 1 ] + {p}_{N} & {p}_{T} > 0 , {p}_{N} > 0 \\ {p}_{N} & {p}_{T} = 0 , {p}_{N} \geq 0 \\ ∞ & otherwise\end{matrix} . \qquad ( 75 )$$

The noise levels of NISQ devices may fluctuate over time, and to account for these statistical variations, a jackknife procedure may be implemented for the mean and variance including bias correction, utilizing, for example, 25 experimental runs per day of 2¹³=8192 shots each across 5 days. Each experimental run was further refined using a measurement noise filter, such as, for example, the measurement noise filter implemented in QISKIT®, which can produce a measurement noise correction map from a collection of calibration measurements which are performed immediately before the experimental shots.

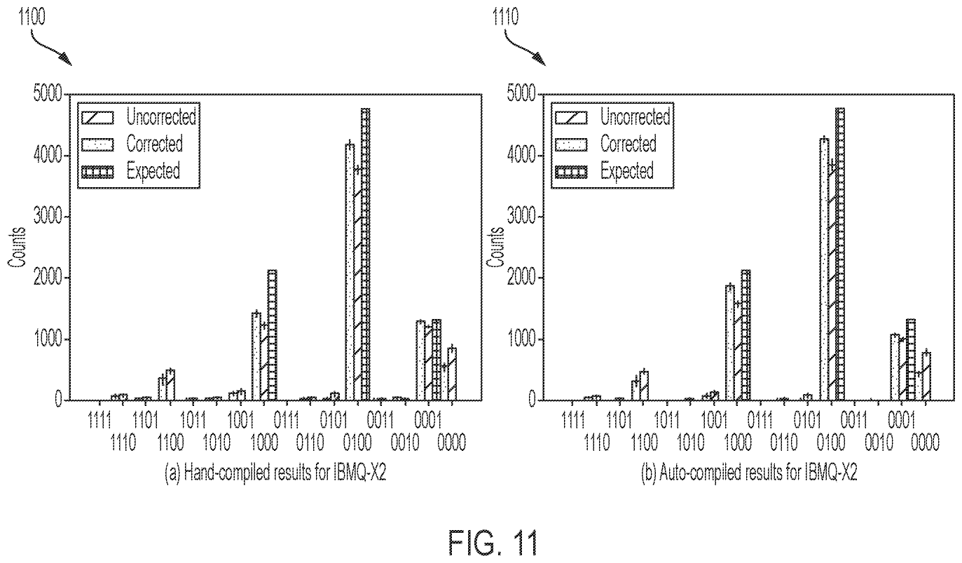

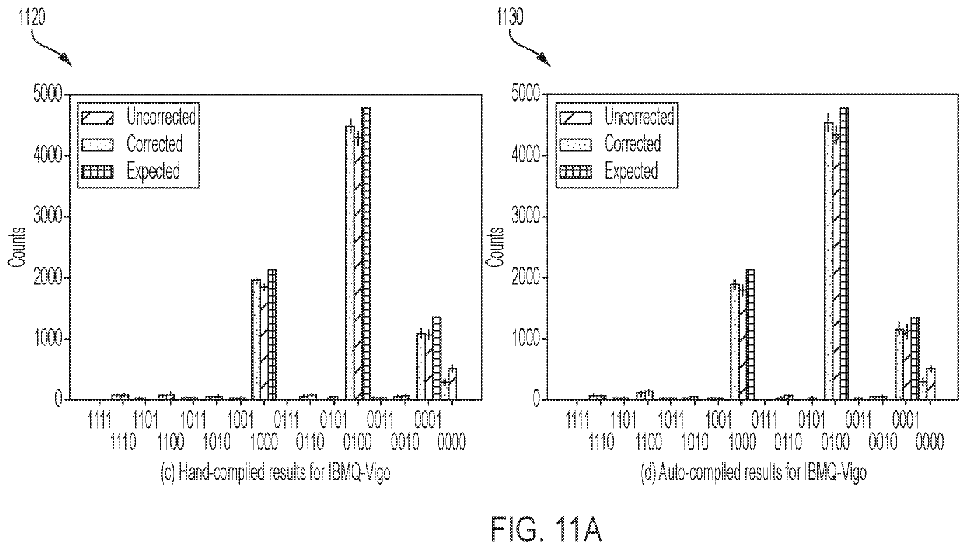

The results of the jackknife analysis on the experimental measurement counts per state are shown in FIG. 11. Here, chart 1100 and chart 1120 are the results for the hand-compiled model circuit 1000 in FIG. 10 and chart 1110 and chart 1130 are for the auto-compiled circuit 1010 in FIG. 10. Additionally, the charts 1100 and 1110 are for a run on the IBMQ-X2 device, and the charts 1120 and 1130 are for a run on the IBMQ-Vigo device. In all of the charts of FIG. 10, the rightmost “expected” bar represents the ideal counts given by the model probability vector P=(8/31; 18/31; 5/31), the center “uncorrected” bars are the raw experimental measurements without noise calibration applied, and the leftmost “corrected” bars are the experimental measurements with the noise calibration applied. The black lines centered on the tops of the uncorrected and the corrected bars indicate the 1σ confidence intervals from the jackknife procedure. As noted above, qubits 0, 1, and 3 map to the probabilities p₀, p₁, and p₂, respectively, and qubit 2 is the ancilla. As can be seen, the application of the measurement noise filter can improve the fidelity of the results. Also, the results for the Vigo device in charts 1120 and 113 are closer to the ideal results than for the IBMQ-X2 shown in charts 1100 and 1110. The largest probability state resulting from errors is the state |0000 [symbol] with no “hot” physical bits, followed by |1100 [symbol] , with the two highest probability physical bits “hot.” The outcomes involving the ancilla qubit in the |1 [symbol] state can be removed in post-selection because the sequential preparation scheme should end with the ancilla in the |0 [symbol] state as described above, but this results in small corrections for this example case. Finally, the auto-compiled results are shown using the approach for compiling the MPS models and are generally closer to the ideal results than the hand-compiled circuits, though this may not be true for each state individually.

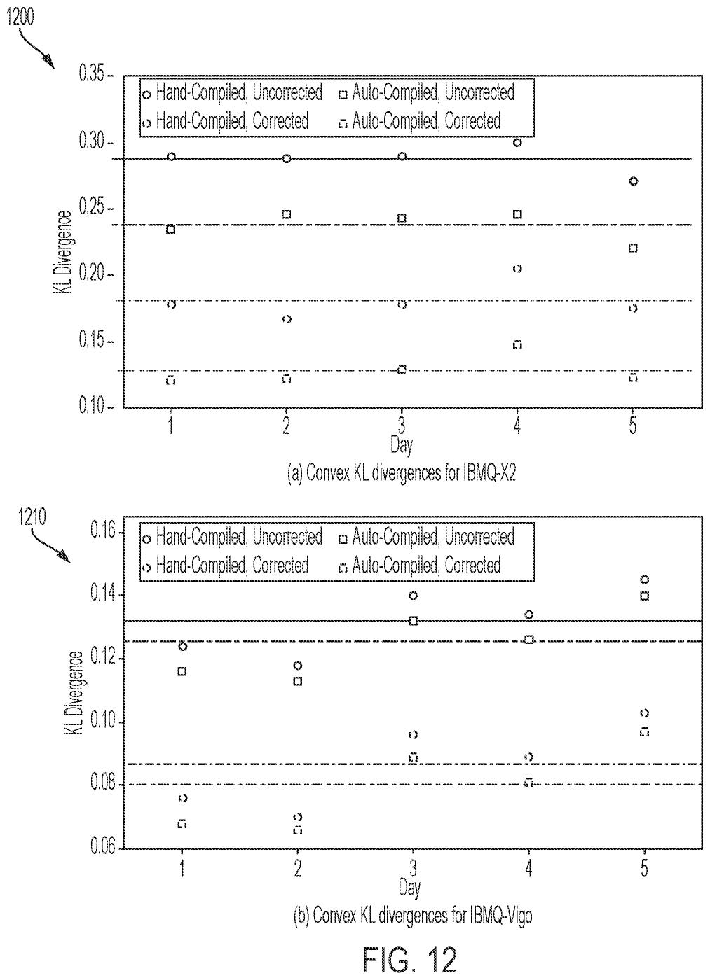

Referring to FIG. 12, the KL (Kullback-Leibler) divergence (i.e., the convex KL divergence as provided in Eq. (75)) is shown between the ideal, noiseless probabilities of measuring each individual quantum state and the measurement probabilities estimated from 25 experiments of 2¹³ shots without (filled symbols) and with (empty symbols) the measurement noise calibration filter applied. The KL divergence is shown in a chart 1200 as a function of an experimental run day for the IBMQ-X2 and in a chart 1210 for the IBMQ-Vigo devices. The filled symbols use the raw experimental counts and empty symbols use the counts with measurement noise filter applied. Lines indicate the KL divergences computed using all measurements from all days. The x axis denotes consecutive experimental days, and the horizontal points for each day indicate the KL divergence resulting from the distributions averaged over all days. Clearly, the application of the measurement noise filter improves the estimation of probabilities, as indicated by a lower KL divergence with respect to the ideal results. In addition, the auto-compiled circuits (squares) show a lower KL divergence than the hand-compiled circuits (circles), likely due to their shallower circuits. Finally, it is shown that the Vigo results in in chart 1210 have lower KL divergence than the IBMQ-X2 results in in chart 1200, indicating an overall lower noise level for these days, in spite of the day-to-day fluctuations in the KL divergence, being comparable in magnitude between the two machines.

According to the example methods and workflows described herein, classical data may be encoded into quantum states using an embedding map, the ensemble of quantum states may then be learned or trained as a TN machine, such as a TM Born machine, using a classical DMRG-like procedure with, for example, gradient descent of the negative log-likelihood, and the model may be compiled into operations for target quantum hardware to obtain data samples as measurement outcomes. Using MPS-based models may enable the use of highly quantum resource-efficient sequential preparation schemes requiring [symbol] (1) qubits for a classical data vector length N and [symbol] (log χ) qubits for bond dimension χ, which may encapsulate the model expressivity. Additionally, several optimizations may be implemented in the compilation stage of the workflow, such as the introduction of the diagonal gauge of the MPS model that utilizes inherent freedom in the model representation to reduce the complexity of the compiled model, as well as greedy heuristics for finding shallow gate sequences matching a target isometry to a specified tolerance given hardware topology and allowed gate constraints. An exactly solvable benchmark model can also be employed requiring two qubits and the performance of the model can be assessed, as provided herein, on, for example, quantum hardware. The results of implementation of the example QAML procedures described herein may be leveraged in a number of contexts including designing and analyzing TN-inspired model structures for scaling towards the classically intractable regime, and serving as “preconditioners” where a model trained using optimal classical strategies may be augmented with additional quantum resources and then trained directly on the quantum device or in a hybrid quantum/classical optimization loop, potentially avoiding local minima and speeding up optimization times.

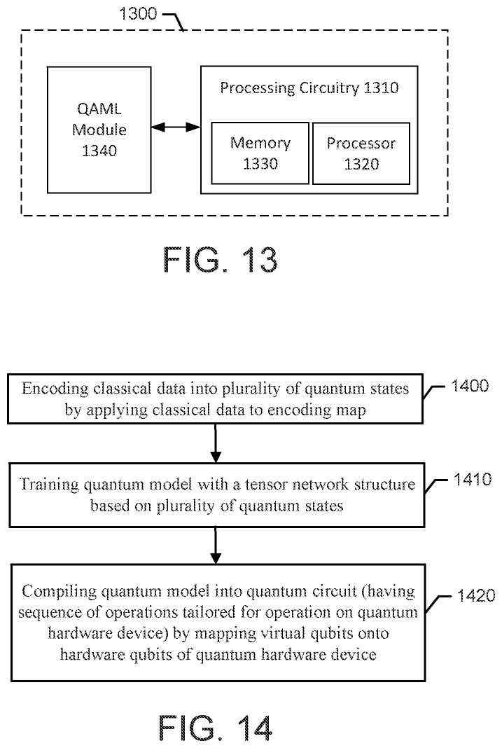

Having provided a detailed description of various example embodiments, the following provides a description of various example embodiments implemented by processing circuitry and embodied as additional example methods. In this regard, with reference to FIG. 13, an example configuration of an apparatus 1300 for implementing various example embodiments is provided as a block diagram. In this regard, the apparatus 1300 includes processing circuitry 1310. Processing circuitry 1310 may, in turn, include processor 1320, and a memory 1330. The processing circuitry 1310 may also include or be in communication with a QAML module 1340 that is configured via the processor 1320 and the memory 1330 to execute or cause the apparatus 1300 to embody various example embodiments described herein. Additionally, the apparatus 1300 may, according to some example embodiments, include additional components not shown in FIG. 13 and the apparatus 1300 may be a component of a larger system that supports implementation of various example embodiments in, for example, a distributed fashion.

Further, according to some example embodiments, processing circuitry 1310 may be in operative communication with or embody, the memory 1330, the processor 1320, and the QAML module 1340. Through configuration and operation of the memory 1330, the processor 1320, and the processing circuitry 1310 may be configurable to perform various operations as described herein, including the operations and functionalities described with respect to the QAML module 1340. In this regard, the processing circuitry 1310 may be configured to perform computational processing and other computing functionalities according to an example embodiment. In some embodiments, the processing circuitry 1310 may be embodied as a chip or chip set. In other words, the processing circuitry 1310 may include one or more physical packages (e.g., chips) including materials, components or wires on a structural assembly (e.g., a baseboard). The processing circuitry 1310 may be configured to receive inputs (e.g., via peripheral components), perform actions based on the inputs, and generate outputs (e.g., for provision to peripheral components). In an example embodiment, the processing circuitry 1310 may include one or more instances of a processor 1320, associated circuitry, and memory 1330. As such, the processing circuitry 1310 may be embodied as a circuit chip (e.g., an integrated circuit chip, such as a field programmable gate array (FPGA)) configured (e.g., with hardware, software or a combination of hardware and software) to perform operations described herein.

In an example embodiment, the memory 1330 may include one or more non-transitory memory devices such as, for example, volatile or non-volatile memory that may be either fixed or removable. The memory 1330 may be configured to store information, data, applications, instructions or the like for enabling, for example, the functionalities described with respect to QAML module 1340. The memory 1330 may operate to buffer instructions and data during operation of the processing circuitry 1310 to support higher-level functionalities, and may also be configured to store instructions for execution by the processing circuitry 1310. The memory 1330 may also store various information used to support the implementation of various example embodiments. According to some example embodiments, various data stored in the memory 1330 may be generated based on other data and stored or the data may be retrieved via a communications interface and stored in the memory 1330.

As mentioned above, the processing circuitry 1310 may be embodied in a number of different ways. For example, the processing circuitry 1310 may be embodied as various processing means such as one or more processors 1310 that may be in the form of a microprocessor or other processing element, a coprocessor, a controller or various other computing or processing devices including integrated circuits such as, for example, an ASIC (application specific integrated circuit), an FPGA, or the like. In an example embodiment, the processing circuitry 1310 may be configured to execute instructions stored in the memory 1330 or otherwise accessible to the processing circuitry 1310. As such, whether configured by hardware or by a combination of hardware and software, the processing circuitry 1310 may represent an entity (e.g., physically embodied in circuitry—in the form of processing circuitry 1310) capable of performing operations according to example embodiments while configured accordingly. Thus, for example, when the processing circuitry 1310 is embodied as an ASIC, FPGA, or the like, the processing circuitry 1310 may be specifically configured hardware for conducting the operations described herein. Alternatively, as another example, when the processing circuitry 1310 is embodied as an executor of software instructions, the instructions may specifically configure the processing circuitry 1310 to perform the operations described herein.

The QAML module 1340 may, according to some example embodiments, be circuitry that is part of, or a configuration of, the processor 1320, possibly in combination with the memory 1330. As such, the QAML module 1340 may be configured to cause the processing circuitry 1310 to perform various functionalities as a component of the apparatus 1300. As such, the QAML module 1340, and thus the processing circuitry 1310, may be configured to perform various operations as described herein in support of the implementation of various example embodiments.

In this regard, the QAML module 1340 may be configured to encode classical data into a plurality of quantum states by applying the classical data to an encoding map. Additionally, the QAML module 1340 may be configured to train a quantum model based on the plurality of quantum states. In this regard, the quantum model may have a tensor network structure. Further, the QAML module 1340 may be configured to compile the quantum model into a quantum circuit by mapping virtual qubits onto hardware qubits of a quantum hardware device. The quantum circuit includes a sequence of operations tailored for operation on the quantum hardware device.

According to some example embodiments, the QAML module 1340 may be further configured to encode the classical data as classical data vectors to quantum data vectors in a quantum Hilbert space. In this regard, each classical data vector may be encoded in an unentangled product state. Additionally or alternatively, according to some example embodiments, the classical data vectors may be encoded into the quantum Hilbert space, where the quantum Hilbert space may be orthonormal. Additionally or alternatively, according to some example embodiments, the QAML module 1340 may be configured to encode the quantum data vectors into a wavefunction that is structured as a Born machine. Additionally or alternatively, according to some example embodiments, the tensor network structure may include a tensor network topology that captures matrix product states (MPSs). Further, QAML module 1340 may be configured to perform a sequential preparation on each matrix product state of the tensor network structure. Additionally or alternatively, according to some example embodiments, the QAML module 1340 may be configured to implement a diagonal gauge based on the quantum model. Additionally or alternatively, according to some example embodiments, the QAML module 1340 may be configured to implement greedy heuristics for determining gate sequences that match a target isometry and transforming the target isometry into operations of the quantum circuit. Additionally or alternatively, according to some example embodiments, the quantum hardware device may include a NISQ computing device. Additionally or alternatively, according to some example embodiments, the quantum hardware device may include a plurality of qubits in a qubit topology including single-qubit rotations and entangling gates between pairs of qubits. Additionally or alternatively, according to some example embodiments, the quantum circuit may include a plurality of gates. Further, the QAML module 1340 may be configured to minimize a number of entangled gates within the plurality of gates.

Now referencing FIG. 14, an example method for quantum-assisted machine learning is provided in accordance with some example embodiments. The example method may be performed by the processing circuitry 1310. In this regard, the example method may include, at 1400, encoding classical data into a plurality of quantum states by applying the classical data to an encoding map, and, at 1410, the example method may include training a quantum model based on the plurality of quantum states. The quantum model may have a tensor network structure. Additionally, the example method may include compiling the quantum model into a quantum circuit by mapping virtual qubits onto hardware qubits of a quantum hardware device. The quantum circuit may include a sequence of operations tailored for operation on the quantum hardware device.

Additionally, according to some example embodiments, encoding the classical data may include encoding the classical data as classical data vectors to quantum data vectors in a quantum Hilbert space. Further, each classical data vector may be encoded in an unentangled product state. Additionally or alternatively, according to some example embodiments, the classical data vectors may be encoded into the quantum Hilbert space. The quantum Hilbert space may be orthonormal. Additionally or alternatively, according to some example embodiments, training the quantum model may include encoding the quantum data vectors into a wavefunction that is structured as a Born machine. Additionally or alternatively, according to some example embodiments, the tensor network structure may include a tensor network topology that captures matrix product states (MPSs). Further, the example method may further include performing a sequential preparation on each matrix product state of the tensor network structure. Additionally or alternatively, according to some example embodiments, compiling the quantum model may include implementing a diagonal gauge based on the quantum model. Additionally or alternatively, according to some example embodiments, compiling the quantum model may include implementing greedy heuristics for determining gate sequences that match a target isometry and transforming the target isometry into operations of the quantum circuit. Additionally or alternatively, according to some example embodiments, the quantum hardware device may include a NISQ computing device. Additionally or alternatively, according to some example embodiments, the quantum hardware device may include a plurality of qubits in a qubit topology including single-qubit rotations and entangling gates between pairs of qubits. Additionally or alternatively, according to some example embodiments, the quantum circuit may include a plurality of gates. Additionally, compiling the quantum model may include minimizing a number of entangled gates within the plurality of gates.

As used herein, the term “module” is intended to include a computer-related entity, such as but not limited to hardware, software, or a combination of hardware and software. For example, a module may be, but is not limited to being a software or hardware implementation of a process, an object, an executable, and/or a thread of execution, which may be implemented via a processor or computer. By way of example, both an application running on a computing device and/or the computing device can be a module. One or more modules can reside within a process and/or thread of execution and a module may be localized on one computer and/or distributed between two or more computers. In addition, these modules can execute from various computer readable media having various data structures stored thereon. The modules may communicate by way of local and/or remote processes such as in accordance with a signal having one or more data packets, such as data from one module interacting with another module in a local system, distributed system, and/or across a network such as the Internet with other systems by way of the signal. Each respective module may perform one or more functions that will be described in greater detail herein. However, it should be appreciated that although such example is described in terms of separate modules corresponding to various functions performed, some examples need not necessarily utilize modular architectures for employment of the respective different functions. Thus, for example, code may be shared between different modules, or the processing circuitry itself may be configured to perform all of the functions described as being associated with the modules described herein. Furthermore, in the context of this disclosure, the term “module” should not be understood as a nonce word to identify any generic means for performing functionalities of the respective modules. Instead, the term “module” should be understood to be a modular entity that is specifically configured in, or can be operably coupled to, processing circuitry to modify the behavior and/or capability of the processing circuitry based on the hardware and/or software that is added to or otherwise operably coupled to the processing circuitry to configure the processing circuitry accordingly.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements or functions, it should be appreciated that different combinations of elements or functions may be provided by alternative embodiments without departing from the scope of the appended claims. In this regard, for example, different combinations of elements or functions than those explicitly described above are also contemplated as may be set forth in some of the appended claims. In cases where advantages, benefits or solutions to problems are described herein, it should be appreciated that such advantages, benefits or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed is:

1. A method for quantum-assisted machine learning comprising:
encoding, by processing circuitry, classical data into a plurality of quantum states by applying the classical data to an encoding map;
training a quantum model based on the plurality of quantum states, the quantum model including a tensor network structure; and
compiling, by the processing circuitry, the quantum model into a quantum circuit by mapping virtual qubits onto hardware qubits of a quantum hardware device, the quantum circuit comprising a sequence of operations tailored for operation on the quantum hardware device.

2. The method of claim 1, wherein encoding the classical data comprises encoding the classical data as classical data vectors to quantum data vectors in a quantum Hilbert space, and each classical data vector is encoded in an unentangled product state.

3. The method of claim 2, wherein the classical data vectors are encoded into the quantum Hilbert space, the quantum Hilbert space being orthonormal.

4. The method of claim 2, wherein the training the quantum model comprises encoding the quantum data vectors into a wavefunction that is structured as a Born machine.

5. The method of claim 1, wherein the tensor network structure comprises a tensor network topology that captures matrix product states (MPSs); and
wherein the method further comprises performing a sequential preparation on each matrix product state of the tensor network structure.

6. The method of claim 1, wherein compiling the quantum model comprises implementing a diagonal gauge based on the quantum model.

7. The method of claim 1, wherein compiling the quantum model comprises implementing greedy heuristics for determining gate sequences that match a target isometry and transforming the target isometry into operations of the quantum circuit.

8. The method of claim 1, wherein the quantum hardware device comprises a noisy intermediate-scale quantum (NISQ) computing device.

9. The method of claim 1, wherein the quantum hardware device comprises a plurality of qubits in a qubit topology comprising single-qubit rotations and entangling gates between pairs of qubits.

10. The method of claim 1, wherein the quantum circuit comprises a plurality of gates; and
wherein compiling the quantum model comprises minimizing a number of entangled gates within the plurality of gates.

11. An apparatus for developing quantum-assisted machine learning systems comprising processing circuitry, wherein the processing circuitry is configured to:
encode classical data into a plurality of quantum states by applying the classical data to an encoding map;
train a quantum model based on the plurality of quantum states, the quantum model including a tensor network structure; and
compile the quantum model into a quantum circuit by mapping virtual qubits onto hardware qubits of a quantum hardware device, the quantum circuit comprising a sequence of operations tailored for operation on the quantum hardware device.

12. The apparatus of claim 11, wherein the processing circuitry configured to encode the classical data is further configured to encode the classical data as classical data vectors to quantum data vectors in a quantum Hilbert space, wherein each classical data vector is encoded in an unentangled product state.

13. The apparatus of claim 12, wherein the classical data vectors are encoded into the quantum Hilbert space, the quantum Hilbert space being orthonormal.

14. The apparatus of claim 12, wherein the processing circuitry configured to train the quantum model is further configured to encode the quantum data vectors into a wavefunction that is structured as a Born machine.

15. The apparatus of claim 11, wherein the tensor network structure comprises a tensor network topology that captures matrix product states (MPSs); and
wherein the processing circuitry is further configured to perform a sequential preparation on each matrix product state of the tensor network structure.

16. The apparatus of claim 11, wherein the processing circuitry configured to compile the quantum model is further configured to implement a diagonal gauge based on the quantum model.

17. The apparatus of claim 11, wherein the processing circuitry configured to compile the quantum model is further configured to implement greedy heuristics for determining gate sequences that match a target isometry and transforming the target isometry into operations of the quantum circuit.

18. The apparatus of claim 11, wherein the quantum hardware device comprises a noisy intermediate-scale quantum (NISQ) computing device.

19. The apparatus of claim 11, wherein the quantum hardware device comprises a plurality of qubits in a qubit topology comprising single-qubit rotations and entangling gates between pairs of qubits.

20. The apparatus of claim 11, wherein the quantum circuit comprises a plurality of gates; and
wherein the processing circuitry configured to compile the quantum model is further configured to minimize a number of entangled gates within the plurality of gates.
